(19) United States
(12) Patent Application Publication
(10) Pub. No.: US 2003/0162153 A1
(43) Pub. Date: Aug. 28, 2003

(54) System and method for teaching writing

(76) Inventors: Kathleen H. Mohn, Humble, TX (US); Betty L. Hennessey, Odessa, TX (US)

Correspondence Address: Alan R. Thiele, JENKENS & GILCHRIST, P.C., 1445 Ross Avenue, Suite 3200, Dallas, TX, 75202-2799, US

(21) Appl. No.: 10/372,554

(22) Filed: Feb. 21, 2003

Related U.S. Application Data
(60) Provisional application No. 60/358,910, filed on Feb. 22, 2002.

(51) Int. Cl. G09B 11/00

(52) U.S. Cl. 434/162

(57) ABSTRACT

An instructional aid and method for teaching the formation of letters and numerals to pre-writers includes a set of the generic shapes found in letters and numerals. The generic shapes are placed on cards to form letters.

This patent application claims the benefit of U.S. Provisional Patent Application 60/359,910, filed Feb. 22, 2002.

### FIELD OF THE INVENTION

The present invention relates to a system and method for educating pre-readers/pre-writers how to form and make the letters of the alphabet, numbers, words, geometric shapes, and mathematical symbols. The present invention may be used with children just learning to read or write for the first time, or it may be used with adults learning to read and write another language, particularly languages using a different alphabet such as Russian or Greek; or, alternatively, it may be used to teach calligraphy students new and different styles of writing letters.

### BACKGROUND

The proper teaching of linguistic skills such as reading and writing to children is one of the more challenging parts of elementary education. The task of understanding the sound and meaning of a single letter, which is then further complicated by the use of multiple letters to form words, which words then have a sound and a specific meaning, requires the student to put together visual, auditory, and tactile skills. The actual formation of a properly proportioned letter on a writing surface, with a writing implement such as a pencil or a pen, requires eye-hand coordination and a great deal of practice. For many students, the formation of accurate, properly proportioned letters is one of the more difficult aspects of an elementary school education.

Many educators who specialize in elementary education have taken the approach that the best way for a student to learn to form letters is to require the student to continually practice forming letters with the idea that the repetitive nature of the activity will cause the student to eventually memorize the shape of the letter. While the repetitive formation of letters may be satisfactory for some students, it is totally unsatisfactory for other students. Specifically, the repetitive formation of letters is a particularly difficult task for a student with an attention deficit disorder. Accordingly, there is a need in the art for a system by which a student will be able to make properly formed and proportioned letters quickly. Such system should be attractive to children and provide a fun component to the learning of linguistic skills.

While the present invention has been described specifically for its use with children, those of ordinary skill in the art will understand that the present invention also has applicability to adult learners. Such applicability may include the teaching of other languages which are written in alphabets and with letters unlike those typically used to write the English language. Further, the present invention may be used with students of calligraphy who are learning to write in a different style such as that typically known as the Old English style. The Old English style of writing includes a range of basic shapes which are formed together into a letter written in the Old English style. Accordingly, the present invention could be used to assist in the teaching of the calligraphy art.

### SUMMARY

The system and method of the present invention is designed to teach pre-readers/pre-writers how to form symbols used in writing by using generic shapes representing the basic writing strokes used in the writing of a letter. Because each generic shape represents a basic writing stroke, the student will be able to understand how the basic strokes are combined to become letters. By using the disclosed system and method, students will be provided with a system which will teach them how to make the letters of the alphabet and other symbols typically used in writing. Further, the disclosed system and method will enable comprehension that the same shapes can be used to form additional letters when the basic shapes are placed in different directions, angles, etc. The disclosed system and method enables pre-readers and pre-writers to learn the difference between upper and lower case letters and thereby become familiar with the letters of the alphabet, words, geometric shapes, and mathematical symbols. In addition, pre-readers/pre-writers will become familiar with colors and basic shapes and directional methodology for reading printed text when using the disclosed system.

When used by a professional linguistics instructor, the disclosed system and method provides an effective tool for segmenting and identifying the sounds in spoken words. The result obtained from use of the disclosed invention is a rapid enhancement of the size of vocabulary taught in elementary schools, to include numbers, shapes, colors, directions, and categories. The disclosed system may also be used to identify and isolate the initial and final sounds of a spoken word, as well as assisting in the development of critical listening skills to interpret and evaluate written symbols. By use of the disclosed system and method, pre-readers/pre-writers receive significant help in recognizing repeated sounds and rhymes as well as associating spoken sounds with the symbol(s) that represent them. Once letters have been learned, users learn how to spell basic words including his/her name.

For English as a second language students, the students' native language can be used as a foundation for English language acquisition. Similarly, English-speaking/writing students can use English as a foundation for learning languages other than English. The disclosed system and method enables a pre-writer to concentrate on how letters are formed so that when pre-writers begin to write, they can concentrate on the mechanics of writing such as pencil grip, paper position, and beginning stroke without having to also learn the shape of each letter simultaneously.

The disclosed system and method enables the teaching of both adults and children to recognize and physically form the letters of the alphabet, numbers, geometric shapes, and mathematical symbols in Latin-based languages and in other languages in which words are formed using a set of symbols or letters contained in what is commonly known as an alphabet.

The physical product furnished to the learner includes a set of generic shapes representing the basic strokes for forming letters or commonly used symbols. Accents may be adapted when accents are used in a particular language such as French or Spanish. Because the very foundation of writing is the use of both straight and curved strokes together to represent letters, the straight and curved generic shapes furnished to the learner are the simplified elements typically used to create a standard written symbol. To enhance the learning process, the shapes may be made of different colors. These different colored shapes are made to correspond to the parts of colored figures on printed cards depicting letters, numbers or symbols. Preferably, the generic shapes will be made of a material which will enable a small child to easily manipulate the selected set of generic shapes into the proper place on the cards which depict letters, numbers, or mathematical symbols. The printed cards will typically be printed with only one letter, figure or symbol per card, with a 1:1 size ratio and colored portions matching the colors of the generic shapes. If desired, the printed cards may also feature primary grade writing tablet lines to designate proportion for page placement of letters or symbols. In yet another embodiment, arrows on the shapes forming the printed figures will designate the direction of the preferred writing stroke used to form the symbol depicted on the card.

### DRAWINGS

A better understanding of the present invention may be had by reference to the drawing figures wherein:

FIG. 1 is a plan view of a typical set of generic shapes used to practice the system and method of the present invention;

FIG. 2A is a plan view of a capital letter A formed using some of the generic shapes depicted in FIG. 1;

FIG. 2B is a plan view of a lower case letter a formed using some of the generic shapes depicted in FIG. 1;

FIG. 3A is a plan view of a capital letter B formed using some of the generic shapes depicted in FIG. 1;

FIG. 3B is a plan view of a lower case letter b formed using some of the generic shapes depicted in FIG. 1;

FIG. 4A is a plan view of a capital letter C formed using some of the generic shapes depicted in FIG. 1;

FIG. 4B is a plan view of a lower case letter c formed using some of the generic shapes depicted in FIG. 1;

FIG. 5A is a plan view of a capital letter D formed using some of the generic shapes depicted in FIG. 1;

FIG. 5B is a plan view of a lower case letter d formed using some of the generic shapes depicted in FIG. 1;

FIG. 6A is a plan view of a capital letter E formed using some of the generic shapes depicted in FIG. 1;

FIG. 6B is a plan view of a lower case letter e formed using some of the generic shapes depicted in FIG. 1;

FIG. 7A is a plan view of a capital letter F formed using some of the generic shapes depicted in FIG. 1;

FIG. 7B is a plan view of a lower case letter f formed using some of the generic shapes depicted in FIG. 1;

FIG. 8A is a plan view of a capital letter G formed using some of the generic shapes depicted in FIG. 1;

FIG. 8B is a plan view of a lower case letter g formed using some of the generic shapes depicted in FIG. 1;

FIG. 9A is a plan view of a capital letter H formed using some of the generic shapes depicted in FIG. 1;

FIG. 9B is a plan view of a lower case letter h formed using some of the generic shapes depicted in FIG. 1;

FIG. 10A is a plan view of a capital letter I formed using some of the generic shapes depicted in FIG. 1;

FIG. 10B is a plan view of a lower case letter i formed using some of the generic shapes depicted in FIG. 1;

FIG. 11A is a plan view of a capital letter J formed using some of the generic shapes depicted in FIG. 1;

FIG. 11B is a plan view of a lower case letter j formed using some of the generic shapes depicted in FIG. 1;

FIG. 12A is a plan view of a capital letter K formed using some of the generic shapes depicted in FIG. 1;

FIG. 12B is a plan view of a lower case letter k formed using some of the generic shapes depicted in FIG. 1;

FIG. 13A is a plan view of a capital letter L formed using some of the generic shapes depicted in FIG. 1;

FIG. 13B is a plan view of a lower case letter l formed using some of the generic shapes depicted in FIG. 1;

FIG. 14A is a plan view of a capital letter M formed using some of the generic shapes depicted in FIG. 1;

FIG. 14B is a plan view of a lower case letter m formed using some of the generic shapes depicted in FIG. 1;

FIG. 15A is a plan view of a capital letter N formed using some of the generic shapes depicted in FIG. 1;

FIG. 15B is a plan view of a lower case letter n formed using some of the generic shapes depicted in FIG. 1;

FIG. 16A is a plan view of a capital letter 0 formed using some of the generic shapes depicted in FIG. 1;

FIG. 16B is a plan view of a lower case letter o formed using some of the generic shapes depicted in FIG. 1;

FIG. 17A is a plan view of a capital letter P formed using some of the generic shapes depicted in FIG. 1;

FIG. 17B is a plan view of a lower case letter p formed using some of the generic shapes depicted in FIG. 1;

FIG. 18A is a plan view of a capital letter Q formed using some of the generic shapes depicted in FIG. 1;

FIG. 18B is a plan view of a lower case letter q formed using some of the generic shapes depicted in FIG. 1;

FIG. 19A is a plan view of a capital letter R formed using some of the generic shapes depicted in FIG. 1;

FIG. 19B is a plan view of a lower case letter r formed using some of the generic shapes depicted in FIG. 1;

FIG. 20A is a plan view of a capital letter S formed using some of the generic shapes depicted in FIG. 1;

FIG. 20B is a plan view of a lower case letter s formed using some of the generic shapes depicted in FIG. 1;

FIG. 21A is a plan view of a capital letter T formed using some of the generic shapes depicted in FIG. 1;

FIG. 21B is a plan view of a lower case letter t formed using some of the generic shapes depicted in FIG. 1;

FIG. 22A is a plan view of a capital letter U formed using some of the generic shapes depicted in FIG. 1;

FIG. 22B is a plan view of a lower case letter u formed using some of the generic shapes depicted in FIG. 1;

FIG. 23A is a plan view of a capital letter V formed using some of the generic shapes depicted in FIG. 1;

FIG. 23B is a plan view of a lower case letter v formed using some of the generic shapes depicted in FIG. 1;

FIG. 24A is a plan view of a capital letter W formed using some of the generic shapes depicted in FIG. 1;

FIG. 24B is a plan view of a lower case letter w formed using some of the generic shapes depicted in FIG. 1;

FIG. 25A is a plan view of a capital letter X formed using some of the generic shapes depicted in FIG. 1;

FIG. 25B is a plan view of a lower case letter x formed using some of the generic shapes depicted in FIG. 1;

FIG. 26A is a plan view of a capital letter Y formed using some of the generic shapes depicted in FIG. 1;

FIG. 26B is a plan view of a lower case letter y formed using some of the generic shapes depicted in FIG. 1;

FIG. 27A is a plan view of a capital letter Z formed using some of the generic shapes depicted in FIG. 1;

FIG. 27B is a plan view of a lower case letter z formed using some of the generic shapes depicted in FIG. 1;

FIGS. 28 is a plan view of the numeral 1 formed using some of the generic shapes depicted in FIG. 1;

FIG. 29 is a plan view of the numeral 2 formed using some of the generic shapes depicted in FIG. 1;

FIG. 30 is a plan view of the numeral 3 formed using some of the generic shapes depicted in FIG. 1;

FIG. 31 is a plan view of the numeral 4 formed using some of the generic shapes depicted in FIG. 1;

FIG. 32 is a plan view of the numeral 5 formed using some of the generic shapes depicted in FIG. 1;

FIG. 33 is a plan view of the numeral 6 formed using some of the generic shapes depicted in FIG. 1;

FIG. 34 is a plan view of the numeral 7 formed using some of the generic shapes depicted in FIG. 1;

FIG. 35 is a plan view of the numeral 8 formed using some of the generic shapes depicted in FIG. 1;

FIG. 36 is a plan view of the numeral 9 formed using some of the generic shapes depicted in FIG. 1; and

FIG. 37 is a plan view of the numeral 0 formed using some of the generic shapes depicted in FIG. 1;

FIG. 38 is a plan view of a division symbol using some of the generic shapes depicted in FIG. 1;

FIG. 39 is a plan view of an equals symbol using some of the generic shapes depicted in FIG. 1;

FIG. 40 is a plan view of a minus symbol using some of the generic shapes depicted in FIG. 1;

FIG. 41 is a plan view of a multiplication symbol using some of the generic shapes depicted in FIG. 1; and

FIG. 42 is a plan view of a plus symbol using some of the generic shapes depicted in FIG. 1.

### DETAILED DESCRIPTION OF THE EMBODIMENTS

A still better understanding of the system and method of the present invention may be had by reference to the drawing figures.

The target age group for the preferred embodiment of this product is two to six year old children who have not developed the fine motor skills required for writing, and those children with developmental or language barriers who are learning the letters, shapes, colors, numbers and symbols required for reading and mathematics. Alternatively, the present invention may be used with adults who have not learned to write or are learning to write in a non-Latin language such as Hebrew.

The simple nature of this invention appeals to the senses of touch, sight, and hearing, which reinforces the generic shapes used to form letters and symbols and their correlation to the printed and spoken word. Users of this invention can learn how letters and symbols are formed, how the letters and symbols are used in conjunction with each other, and how to spell words without the use of pencil, paper and fine motor skills. Once children are at the point of writing with pencil and paper, users of the disclosed invention will be able to concentrate on the actual mechanics of writing, such as pencil grip, paper position, pressure, and strokes. Children will also have a mental image of the figure they are trying to write, as well as an understanding of the stroke(s) necessary to form the image of a letter or a number. The frustration of not being able to write the printed letters correctly is greatly reduced because learners will know what they are doing before they ever pick up the pencil.

Operation

In the preferred embodiment, the instructor will provide each learner with a set of cards depicting the letters or symbols that will be taught during that session. Each card contains an assortment of shapes that includes the necessary basic shapes to complete the selected letter or symbol. If the instruction is about letters, the instructor may choose to say the letter, pronounce the sound associated with the letter, and then use words which begin or end with the letter. The instructor may have the learner trace the letter with their index finger of their writing hand, in the direction of the arrows on the printed figure(s). Next, the learner will choose the basic linear or curved shapes which correspond to the parts of the printed figure(s) and lay them on top of the figure depicted on the card. Initially, the instructor will interact with the learner; but, with repetition, the need for personal involvement by the instructor will diminish. The learner will then be asked to use the shapes and recreate the figure onto a “blank” card which may include writing tablet lines but with no figure to follow. As the learner progresses and learns the alphabet, multiple cards may be used in groups to either spell words or names or used to sight read words.

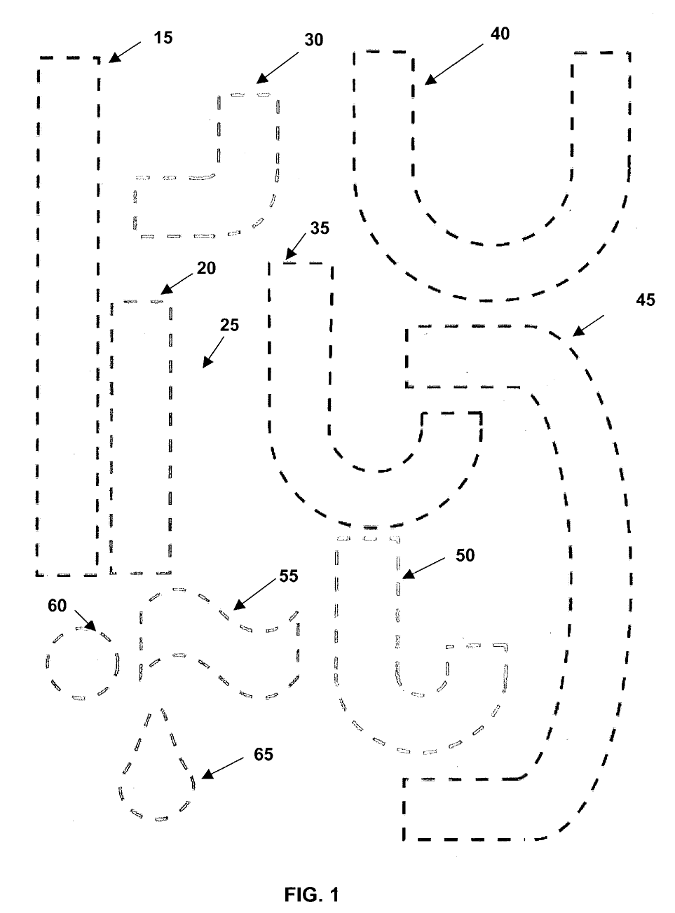

FIG. 1 depicts a set of the plurality of different shapes representing the basic strokes used to form letters or symbols. Specifically, shown are a long straight line 15, a medium straight line 20, and a short straight line 25. Also shown is a substantially right-angled curve 30, a large hook shape 35, and a small hook shape 50. For other letters, a U-shaped piece 40 is included along with a C-shaped piece 45. Special symbols such as a dot 60, a squiggly 55, or an apostrophe 65 may also be included in the set of generic shapes.

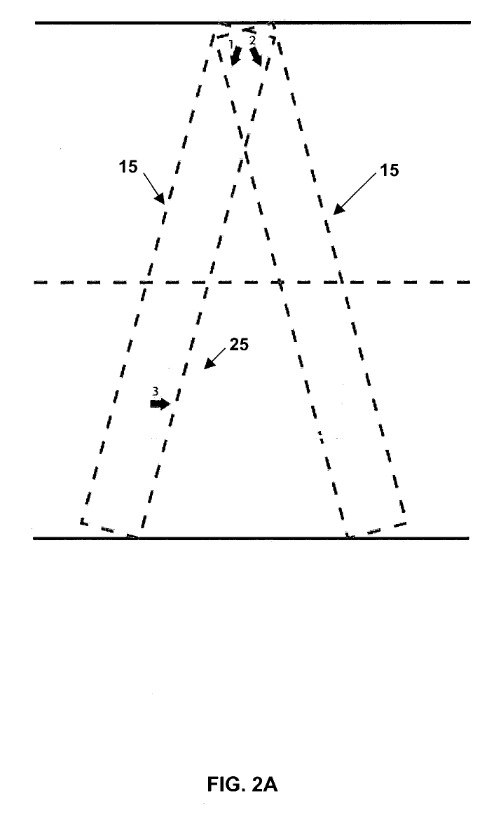

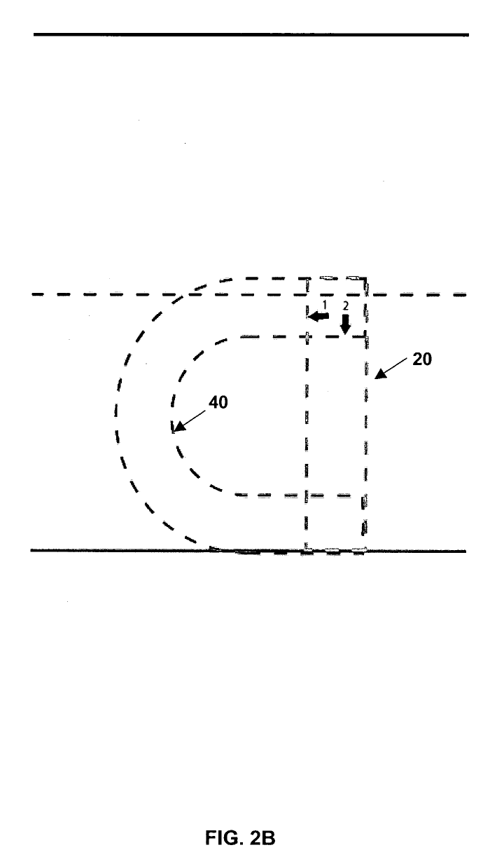

In FIG. 2A, a capital letter A is formed using two long straight lines 15 and a short straight line 25. Note the numbered arrows which may be used to aid the student in learning a sequence of strokes for constructing a letter or symbol. These numbered arrows appear on several other of the appended drawing figures.

In FIG. 2B, a lower case letter a is formed using a u-shaped piece 40 and a medium length straight line 20.

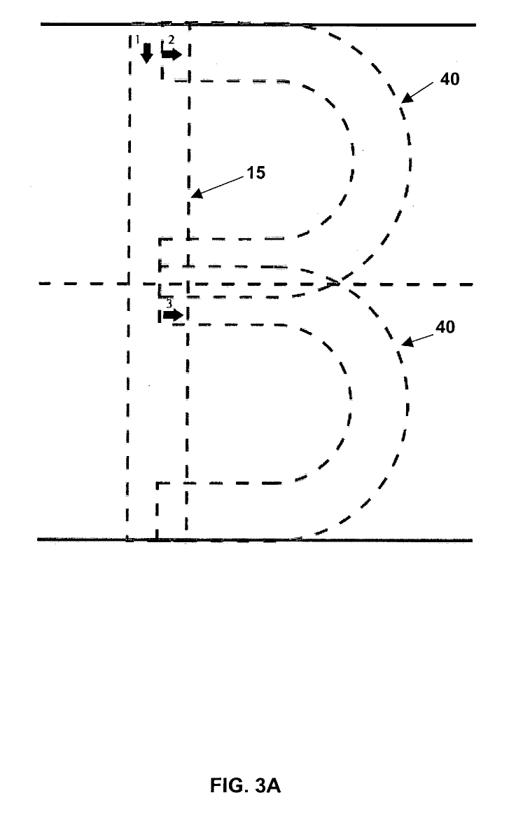

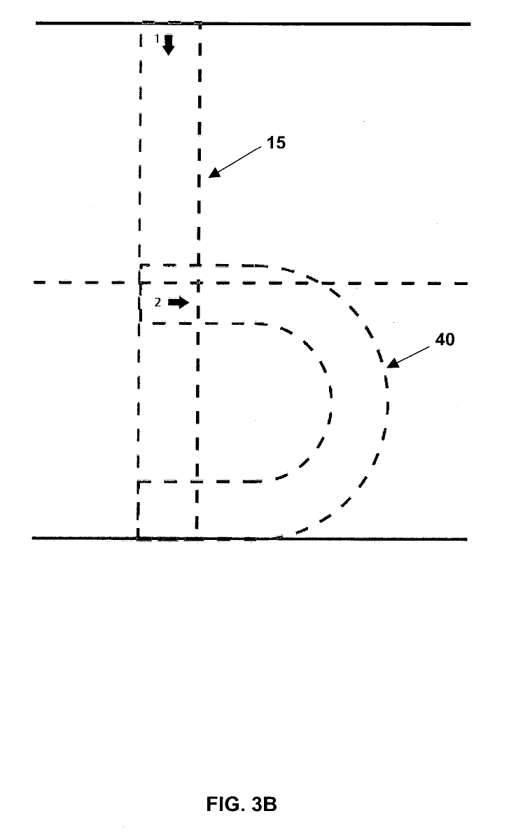

In FIG. 3A, a long straight line 15 is used with two u-shaped pieces 40 to form a capital letter B.

In FIG. 3B, a long straight line 15 is used with a u-shaped piece 40 to form a lower case letter b.

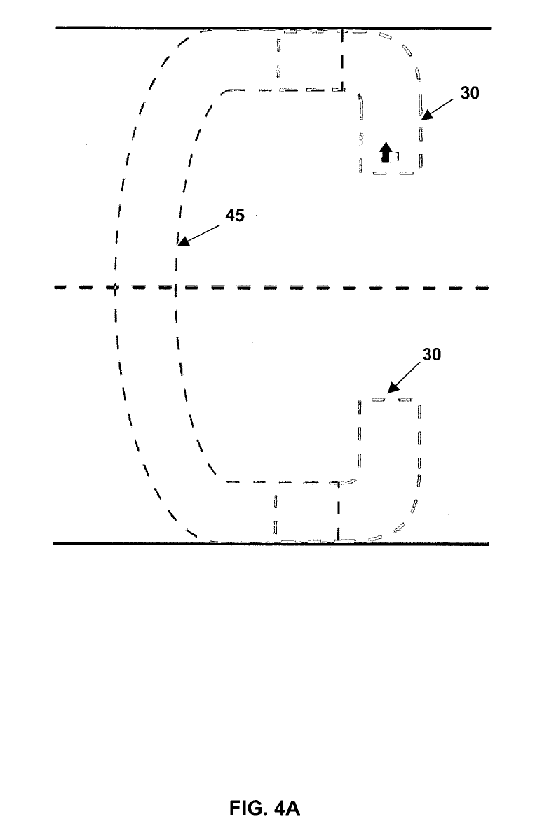

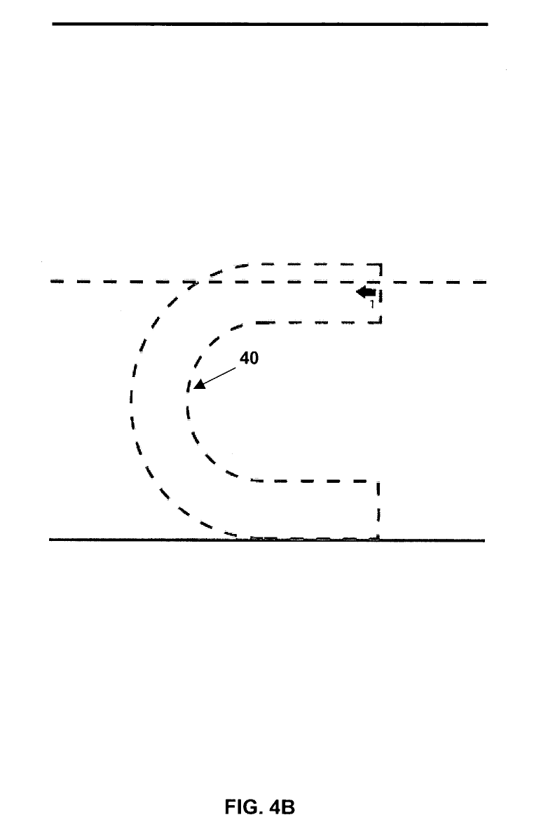

In FIG. 4A, a C-shaped piece 45 is used with two substantially right-angled curve pieces 30 to form a capital letter C.

In FIG. 4B, a lower case letter c consists solely of a small u-shaped piece 40.

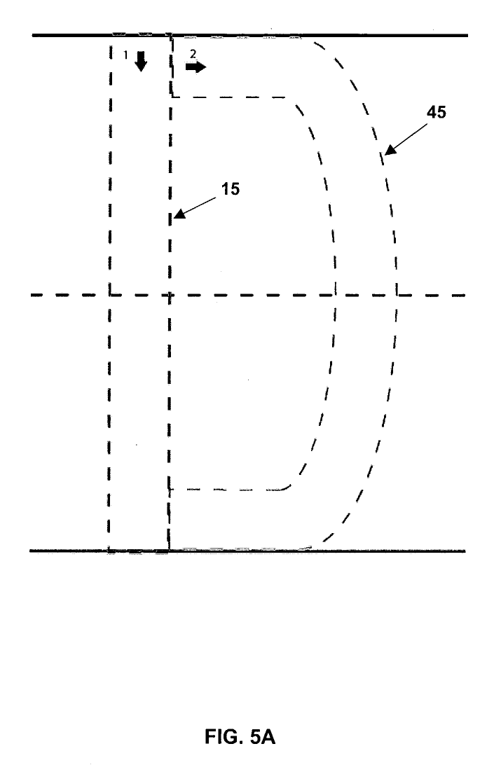

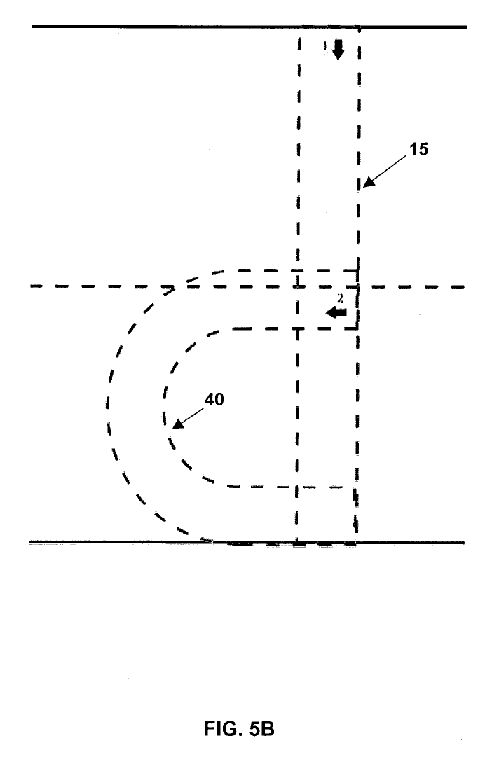

FIG. 5A depicts a capital letter D formed from a long straight line 15 and a C-shaped piece 45.

FIG. 5B shows a lower case letter d formed from a long straight line 15 and a u-shaped piece 40.

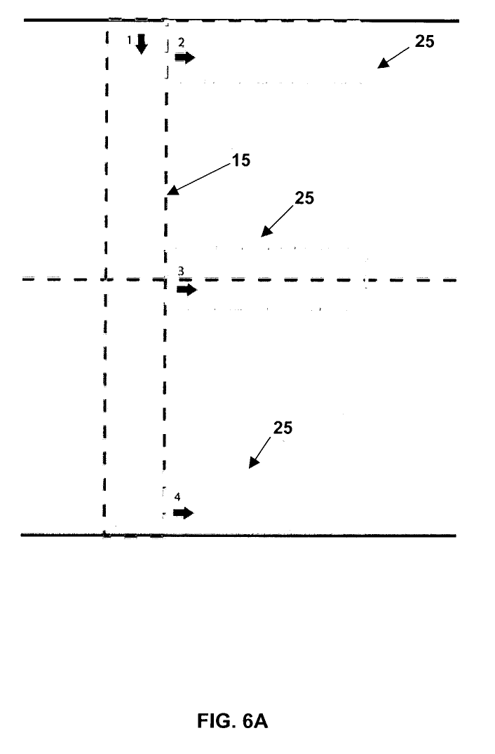

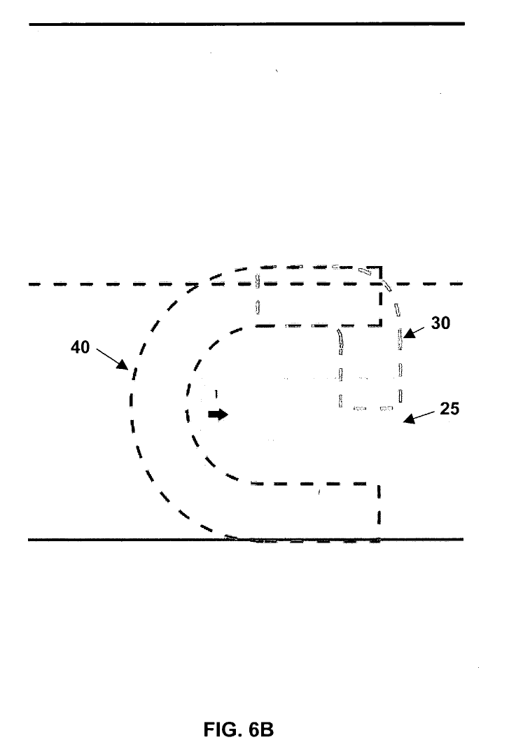

FIG. 6A shows a capital letter E is formed from a long straight line 15 and three short straight lines 25.

In FIG. 6B, a lower case letter e is formed using a u-shaped piece 40, a short straight line 25, and a substantially right angle curve piece 30.

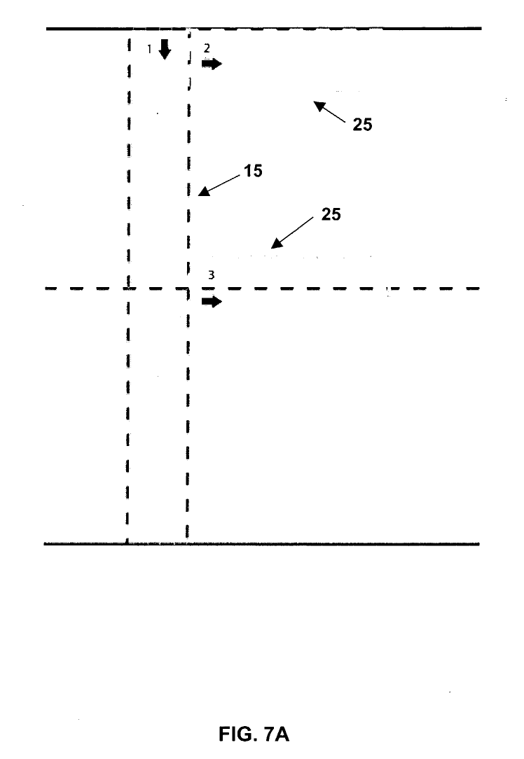

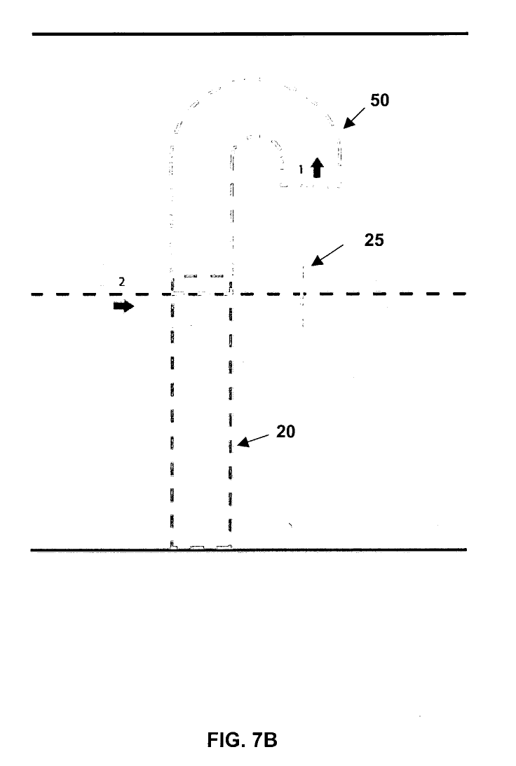

The letter F is shown in FIG. 7A as being formed by a long straight line 15 and two short lines 25. A lower case letter f is shown formed in FIG. 7B using a medium straight line segment 20, a short straight line segment 25, and a small hooked segment 30.

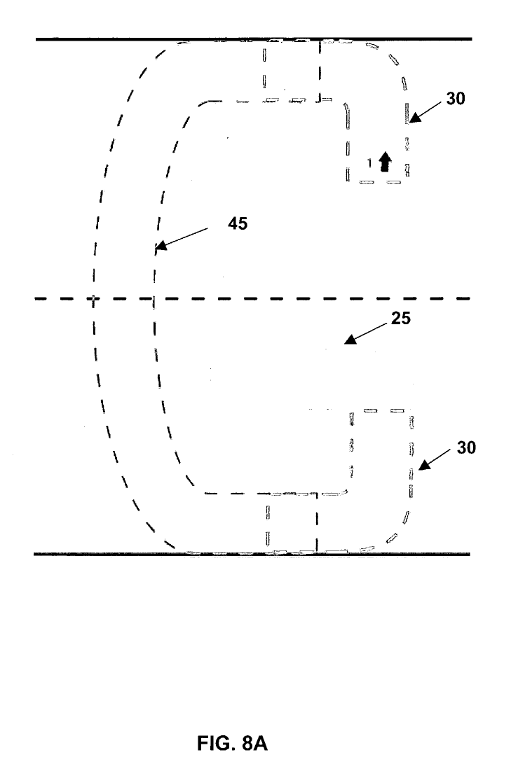

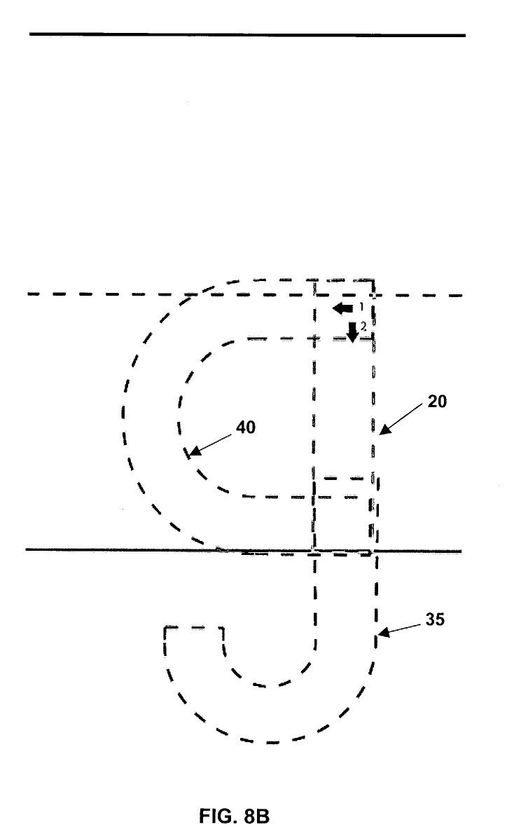

FIG. 8A shows the formation of a G. The G is formed from a large C-shaped piece 45, two small curved pieces 35, and a short straight line segment 25.

The lower case letter g is formed as shown in FIG. 8B using a medium line segment 20 in conjunction with a small u-shaped section 40 and a large hook shape segment 35.

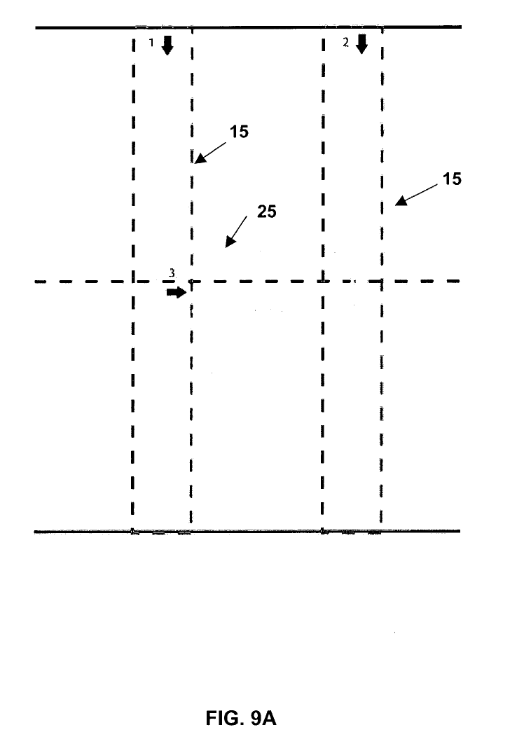

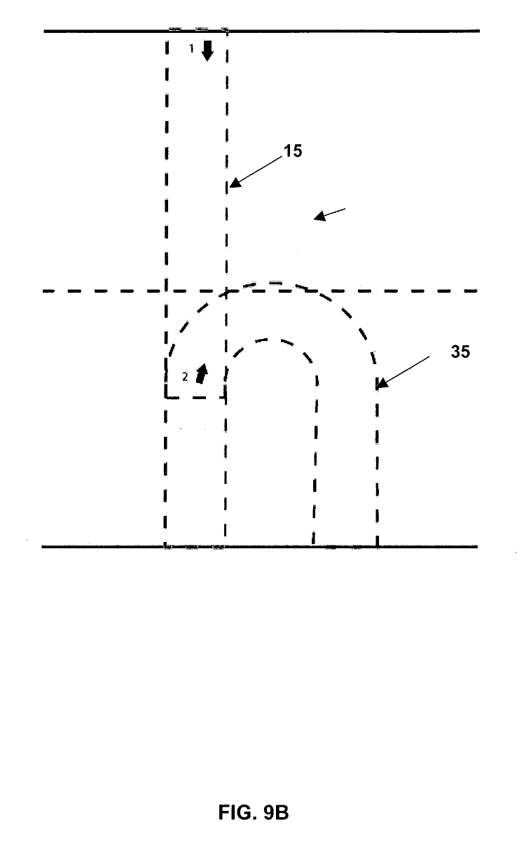

In FIG. 9A, the capital letter H is shown by the use of two long straight line segments 15 and a short straight line segment 25.

A lower case letter h is formed in FIG. 9B using a large hook shape segment 35 and a long straight line segment 15.

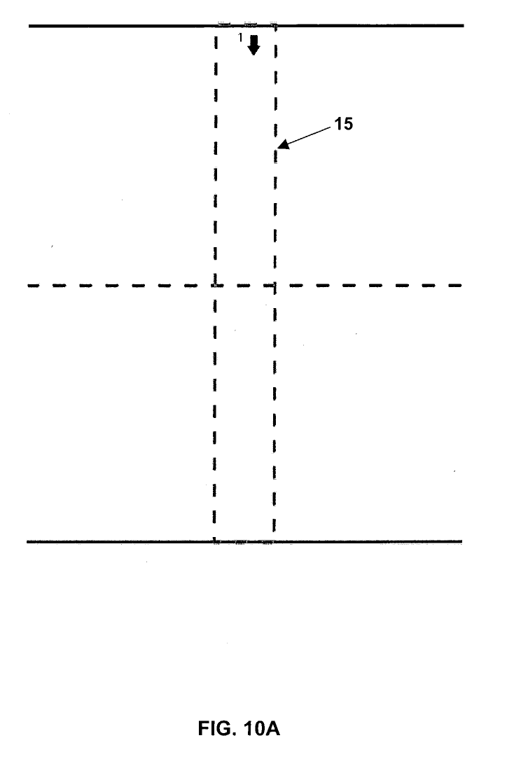

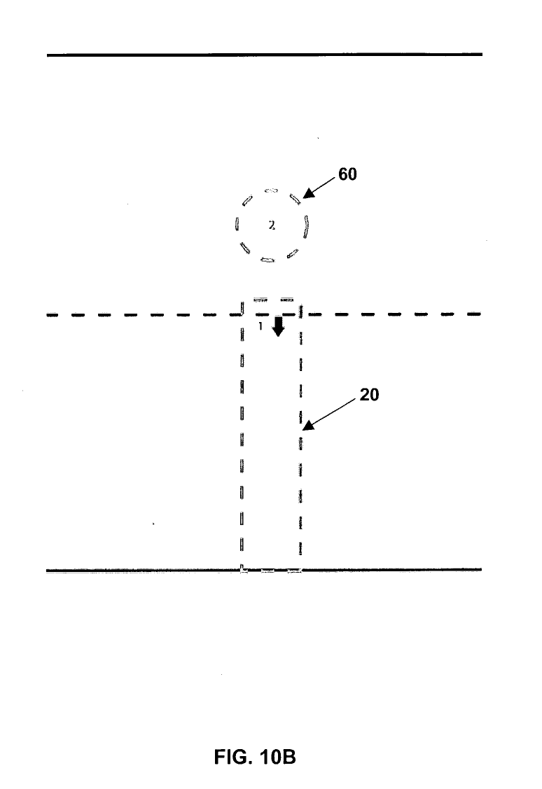

The letter I as depicted in FIG. 10A is quite simple; that is, it only consists of a single long straight line segment 15.

In FIG. 10B a lower case i is shown, including a medium straight line segment 20 and a dot 60.

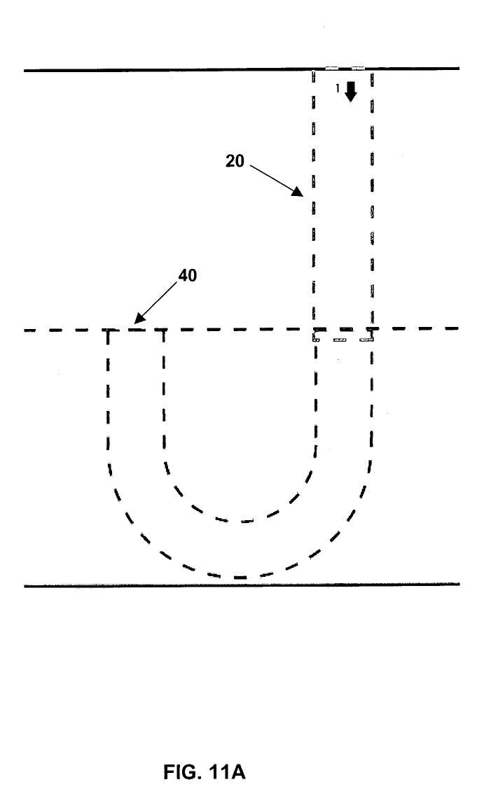

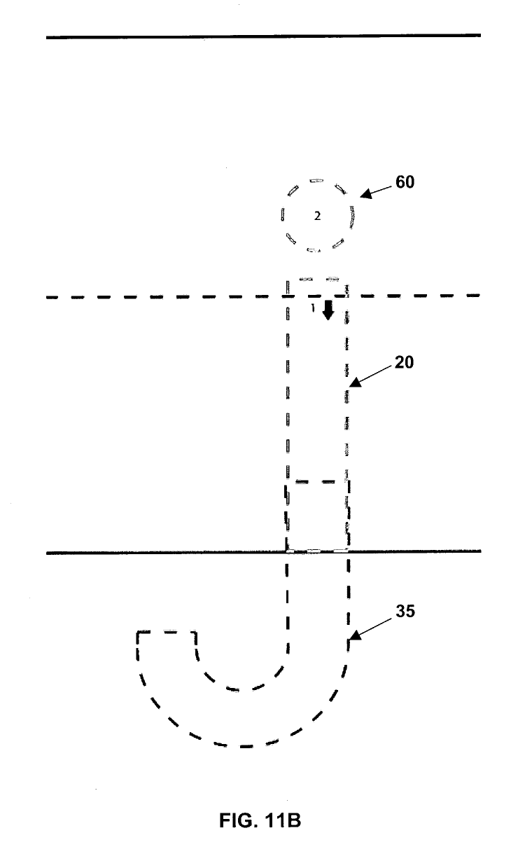

In FIG. 11A, a capital letter J is formed using a medium straight line segment 20 and a u-shaped segment 40.

In FIG. 11B, a lower case letter j is formed using a hook shaped segment 35, a medium straight line segment 20, and a dot 60.

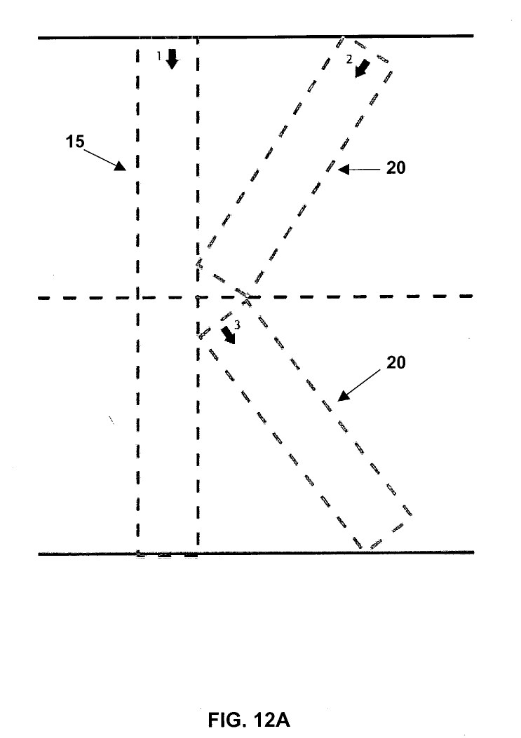

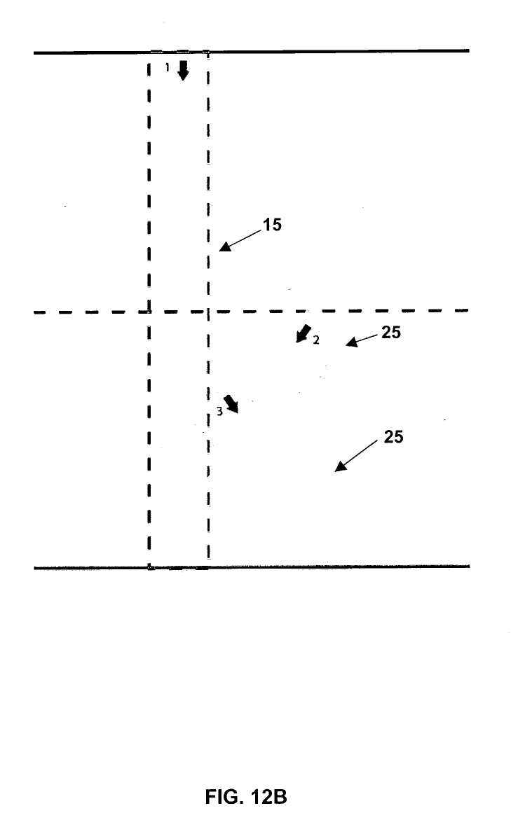

The letter K, as depicted in FIG. 12A, includes a long line segment 15 and two medium straight line segments 20 placed at an angular relationship with respect to the long straight line segment 15.

Similarly, a lower case k may be formed using a long straight line segment 15 and two short straight line segments 25, as shown in FIG. 12B.

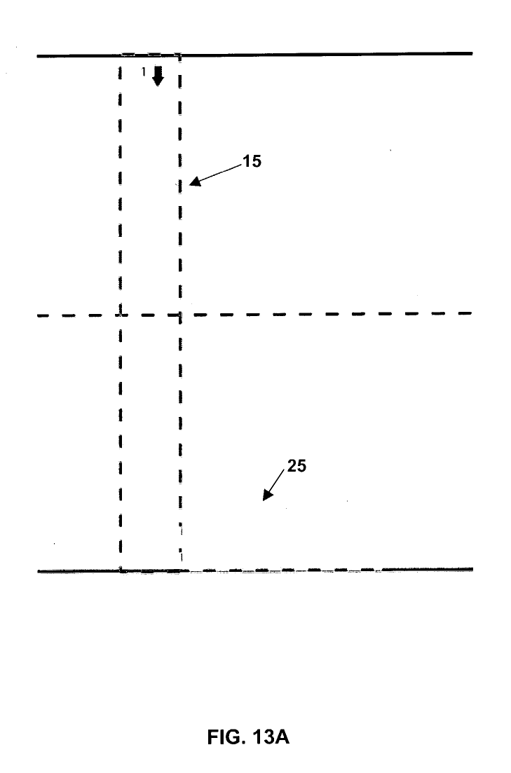

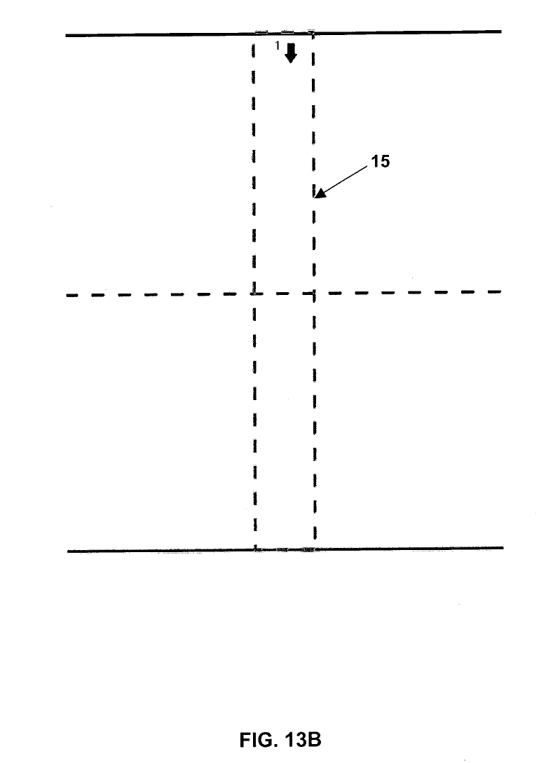

The capital letter L depicted in FIG. 13A includes a long straight line segment 15 and a short straight line segment 25.

The lower case letter l depicted in FIG. 13B includes only a long straight line segment 15.

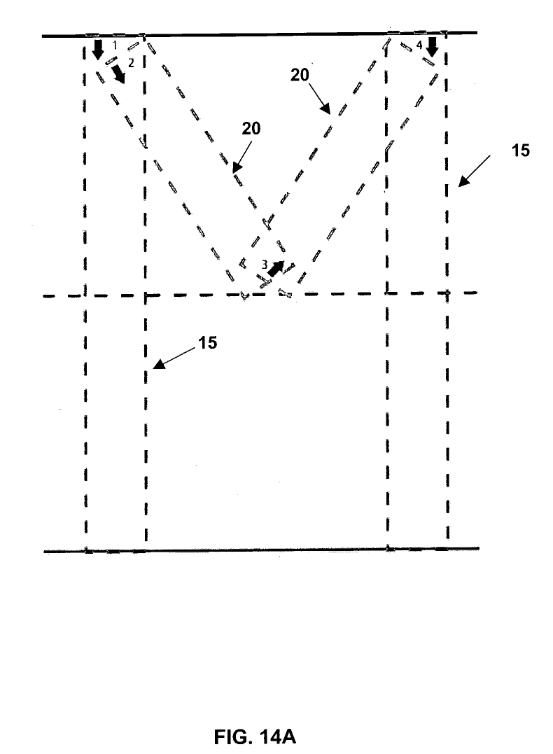

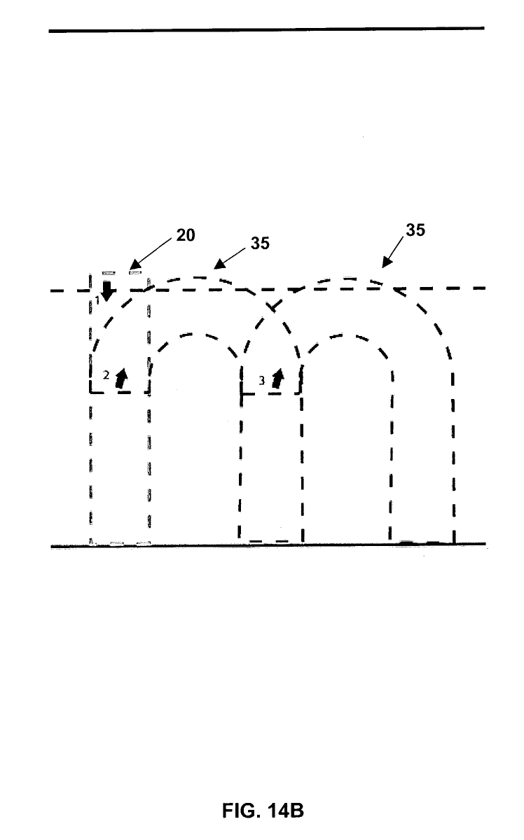

FIG. 14A shows the formation of the capital letter M using two long straight segments 15 and two medium straight line segments 20.

In FIG. 14B, a lower case letter m is formed using a medium straight line segment 20, a first hook shaped segment 35, and a second hook-shaped segment 35.

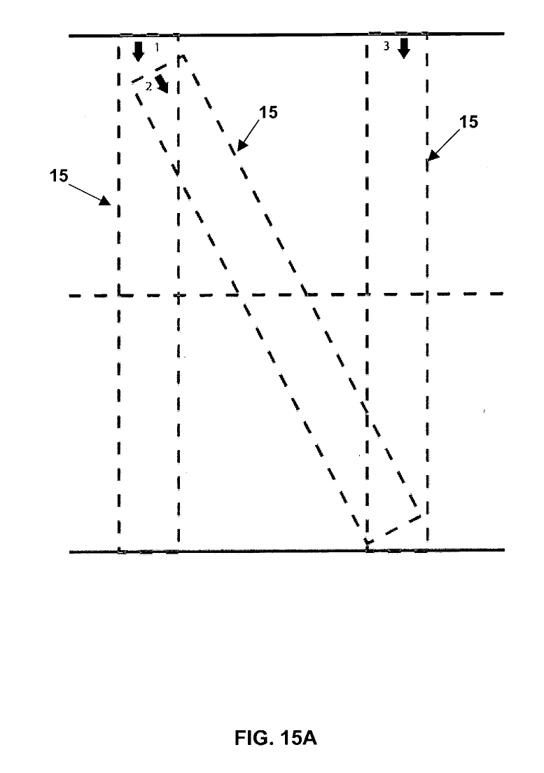

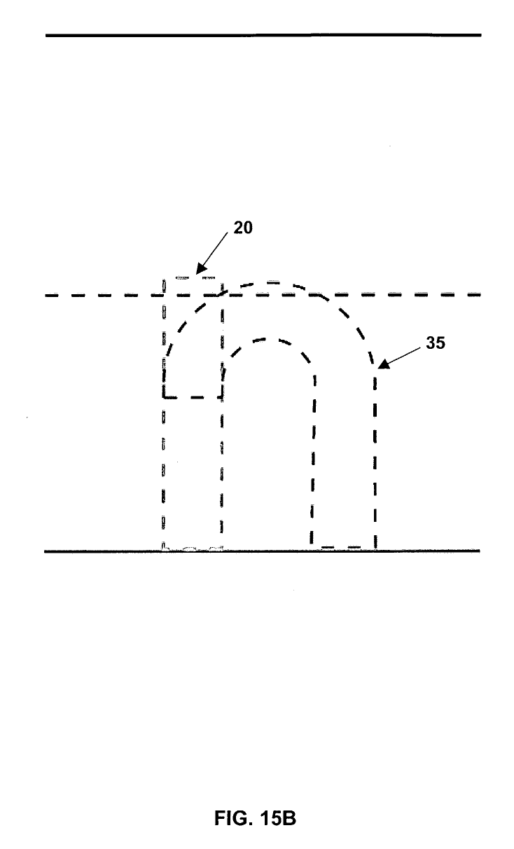

In FIG. 15A, a capital letter N is shown by using three long straight line segments 15.

In FIG. 15B, a lower case letter n is shown using a medium straight line segment 20 and a hook segment 35.

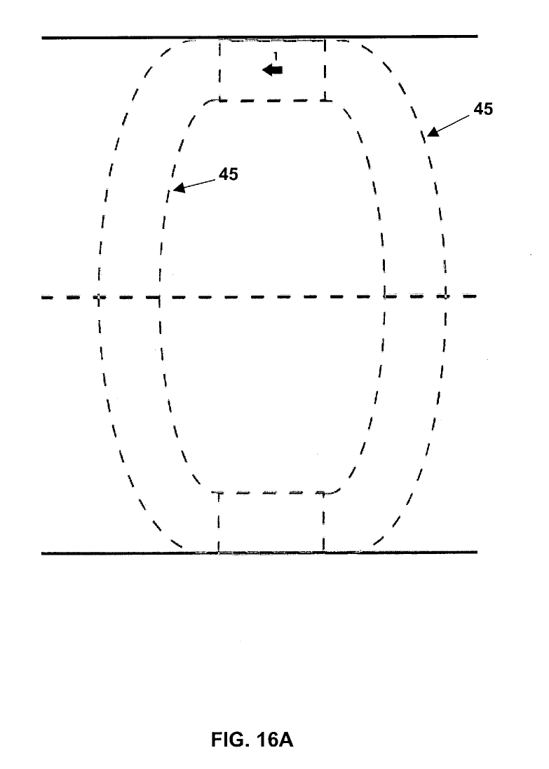

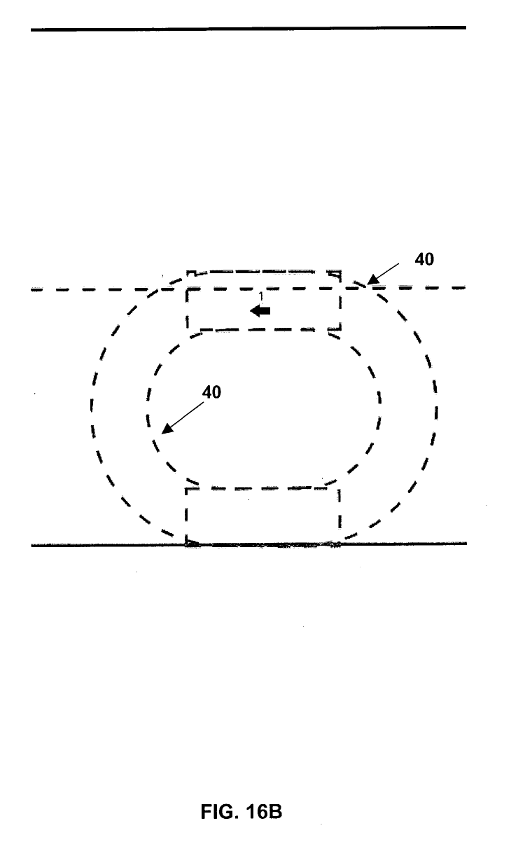

In FIG. 16A, a capital letter 0 is formed using two C-shaped segments 45.

In FIG. 16B, a lower case letter o is formed using two small u-shaped segments 40.

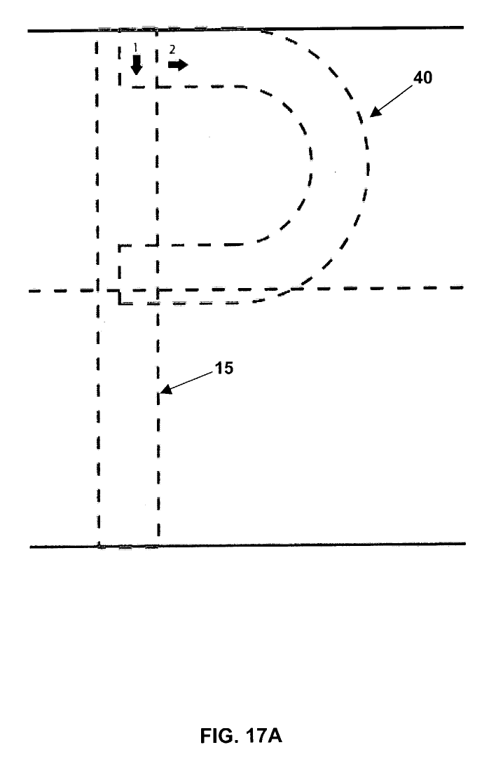

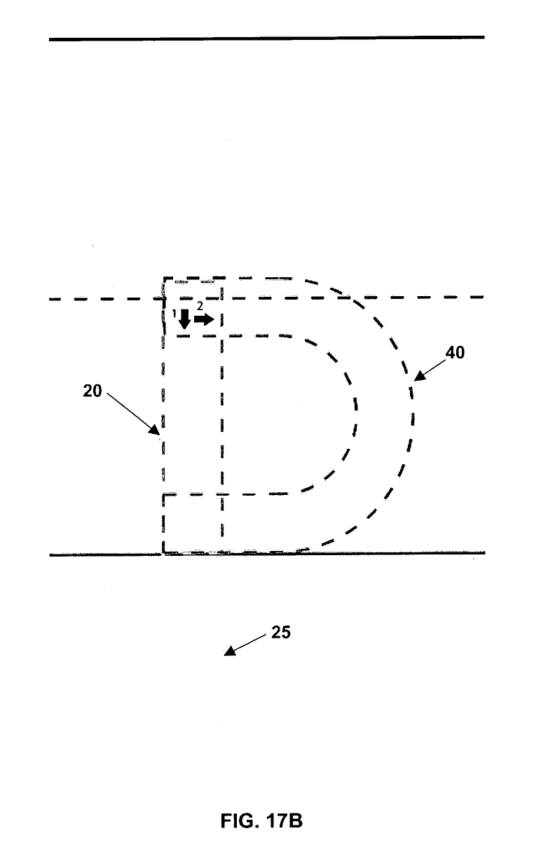

In FIG. 17A is a capital letter P using a long straight line segment 15 and a u-shaped segment 40.

In FIG. 17B is a lower case letter p formed using a u-shaped segment 40, a medium straight line segment 20, and a short straight line segment 25.

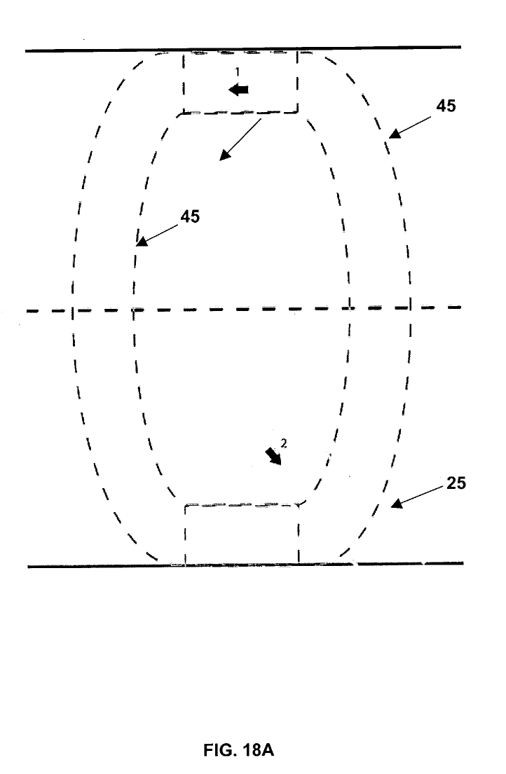

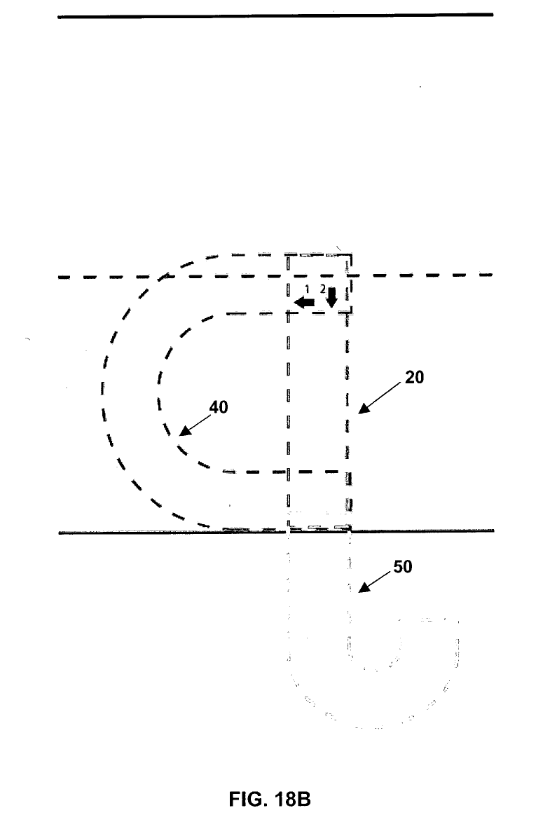

In FIG. 18A, a capital letter Q is formed using two C-shaped segments 45 and a short straight line segment 25.

The lower case letter q is formed using a u-shaped segment 40, a medium straight line segment 20, and a small hook segment 50, as shown in FIG. 18B.

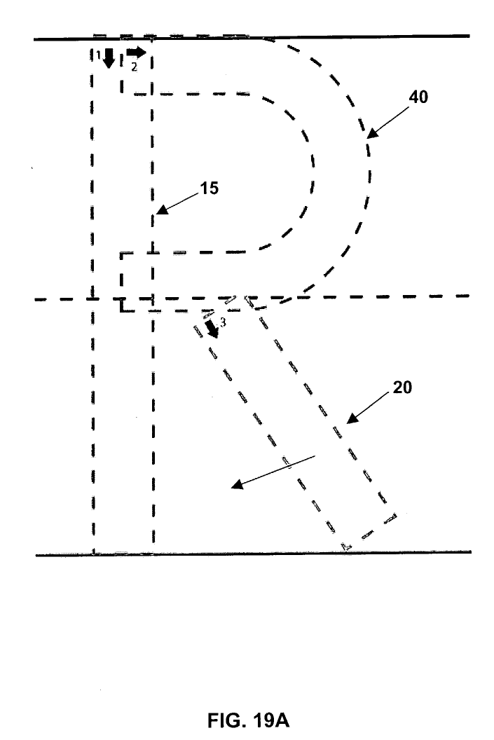

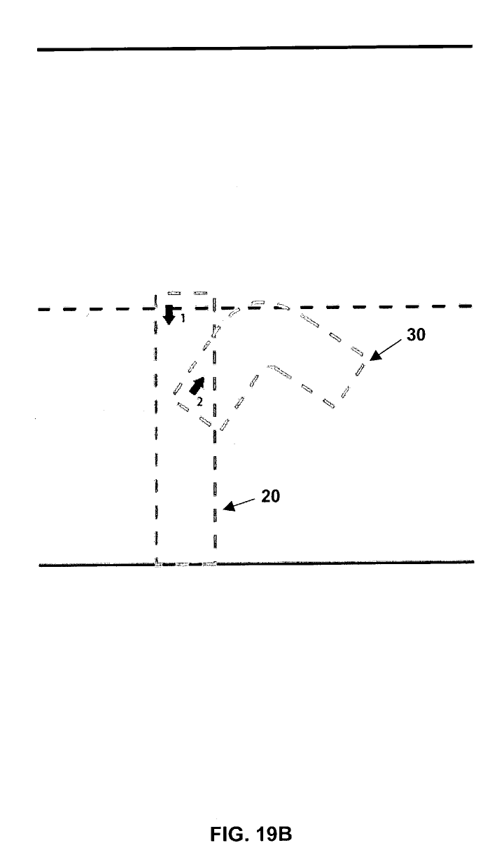

The capital R shown in FIG. 19A uses a long straight line segment 15, a u-shaped segment 40, and a medium straight line segment 20.

The lower case r found in FIG. 19B uses a medium straight line segment 20 and a substantially right angled curve piece 30.

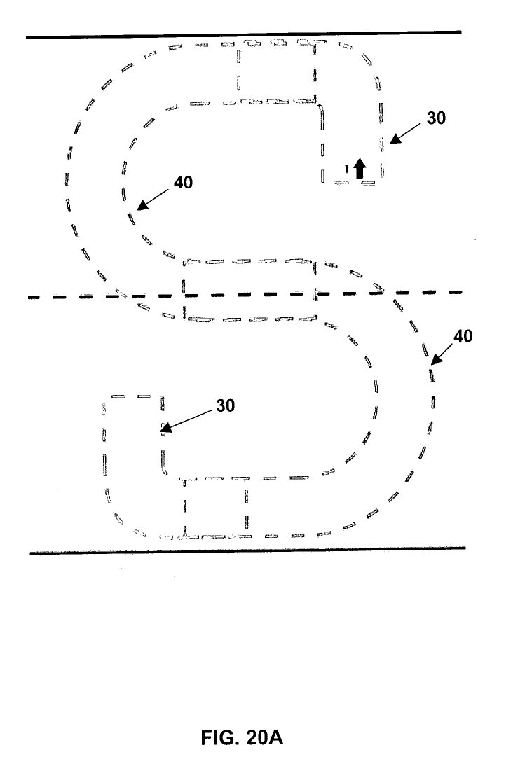

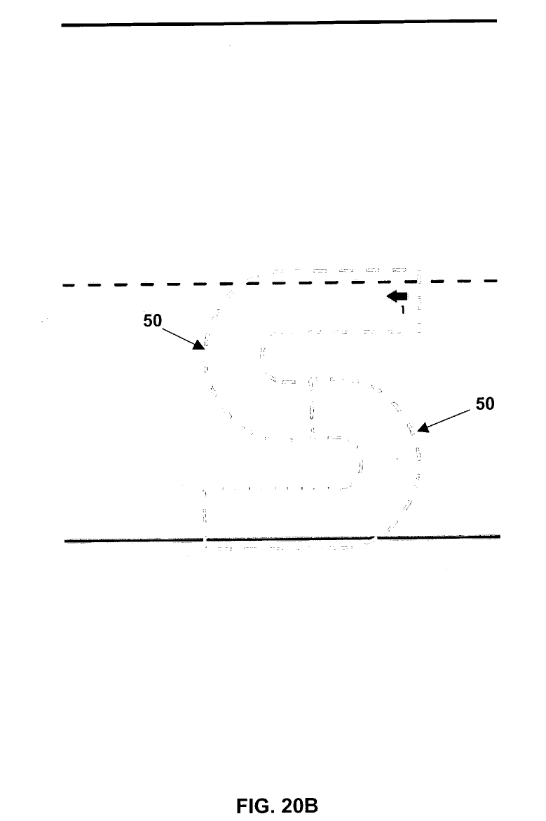

In FIG. 20A is a capital S formed using two u-shaped segments 40 and two substantially right angled curve sections 30.

In FIG. 20B, a lower case s is formed using two small hook shapes 50.

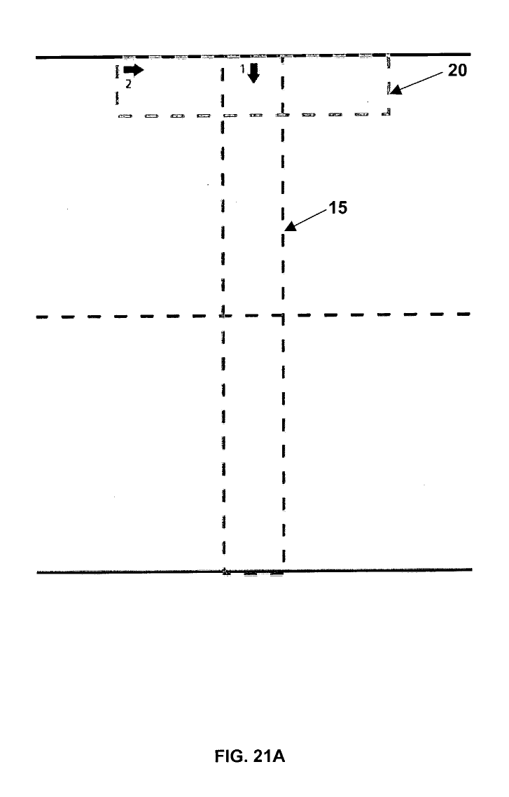

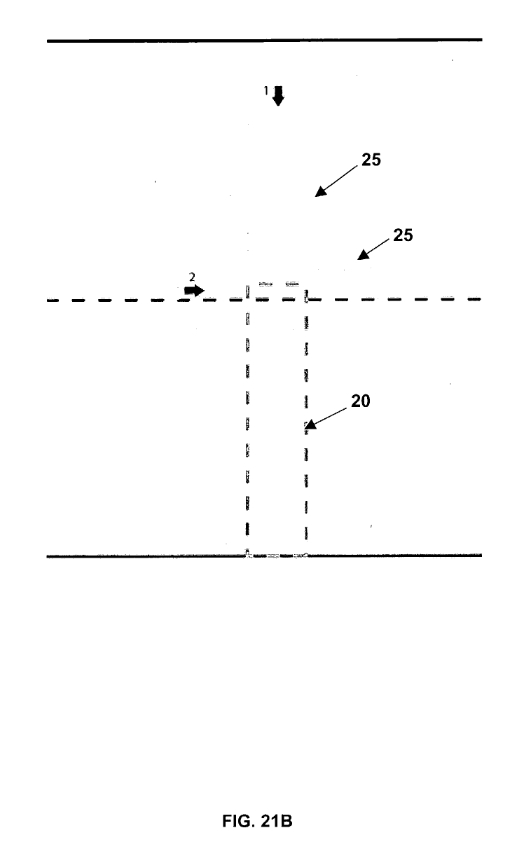

In FIG. 21A, the capital letter T is formed using a long straight line segment and a medium straight line segment 20.

In FIG. 21B, the lower case letter t is formed using a medium straight line segment 20 and two short straight line segments 25.

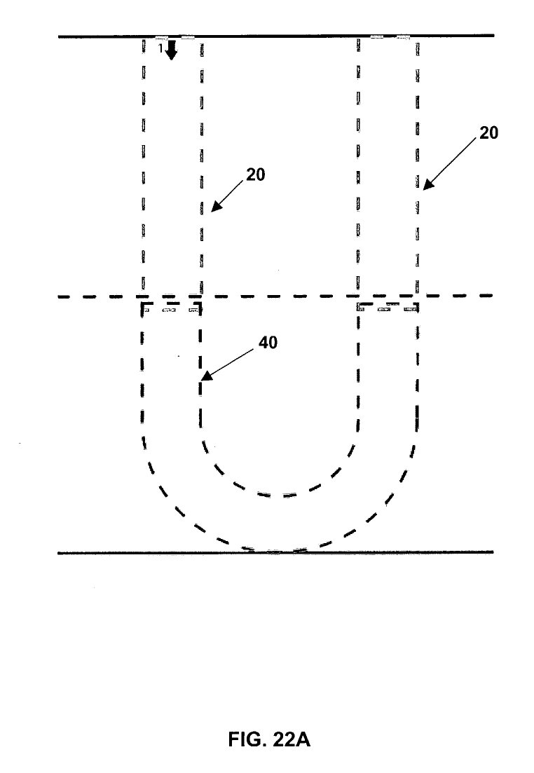

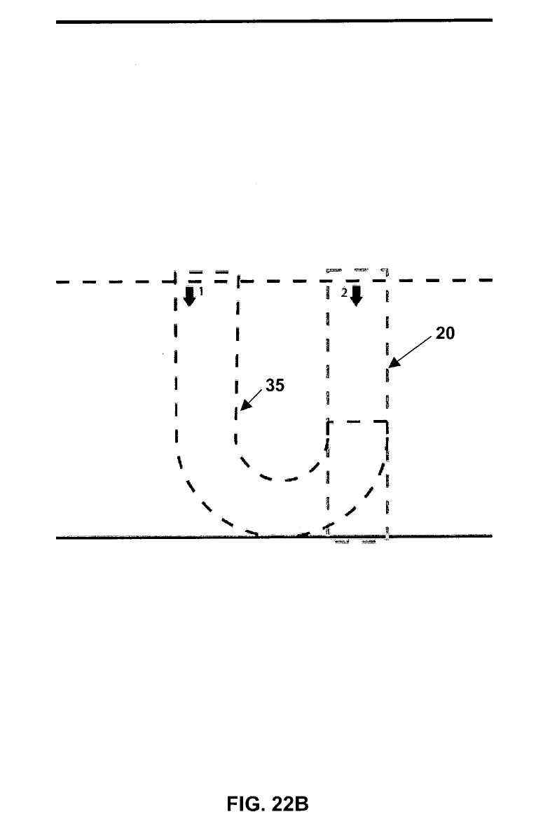

In FIG. 22A, the capital letter U is formed using the u-shaped segment 40 and two medium straight line segments 20.

In FIG. 22B, the letter u is formed using a large hook-shaped segment 35 and a short straight line segment 25.

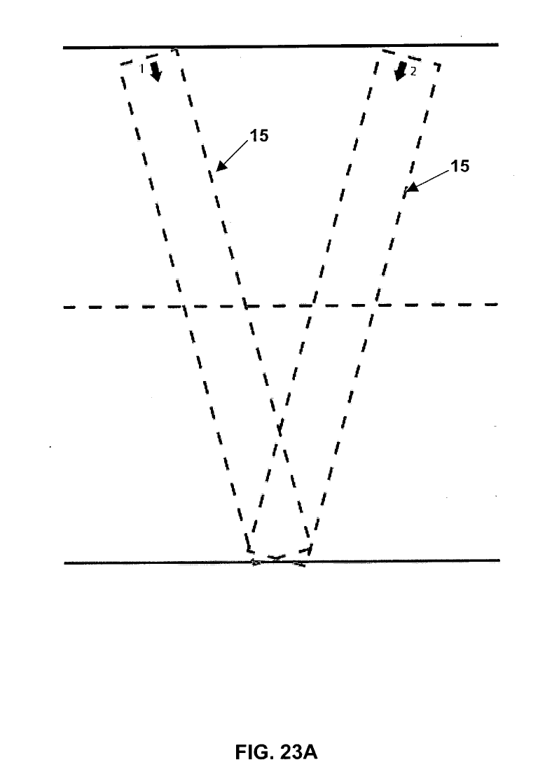

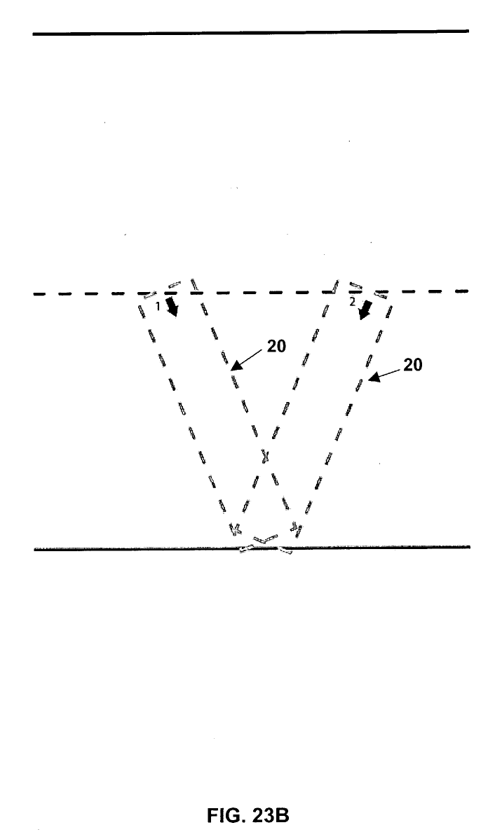

In FIG. 23A, a capital letter V is formed using two long straight line segments 15.

In FIG. 23B, a lower case v is formed using two medium straight line segments 20.

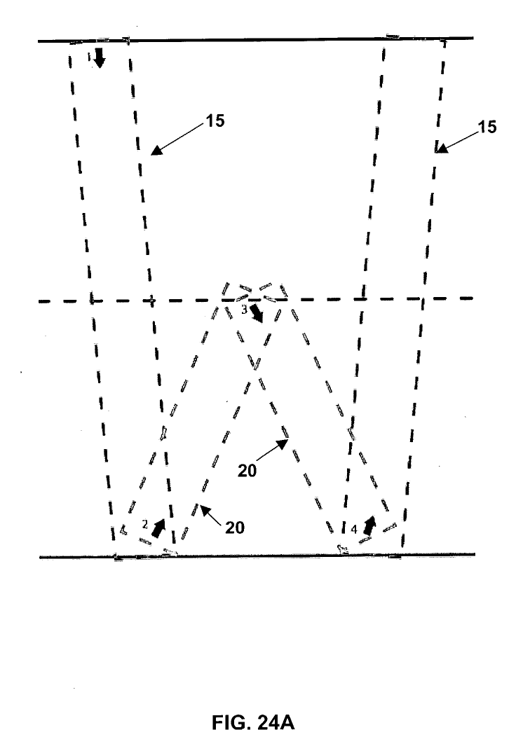

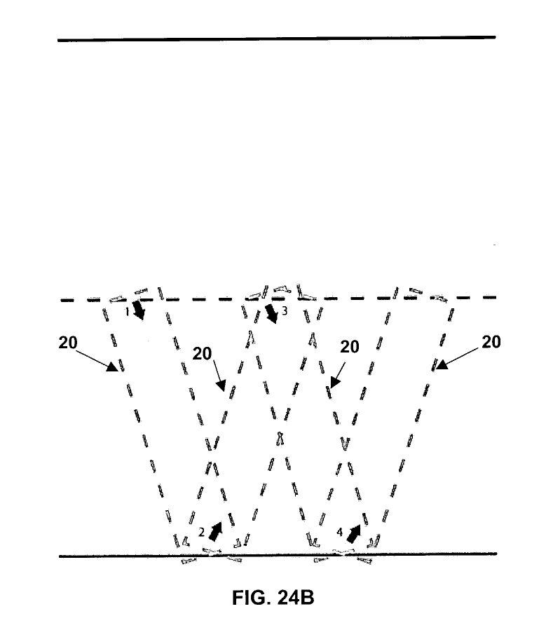

The capital letter W is formed using two long straight line segments 15 and two medium straight line segments 20, as shown in FIG. 24A.

In FIG. 24B, a lower case letter w is formed by using four medium straight line segments 20.

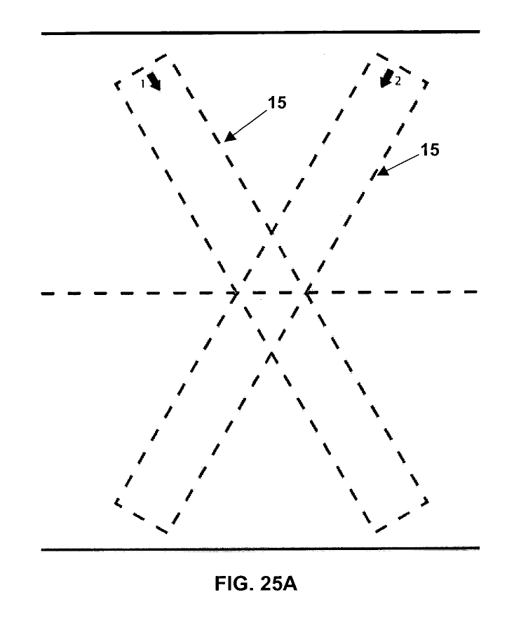

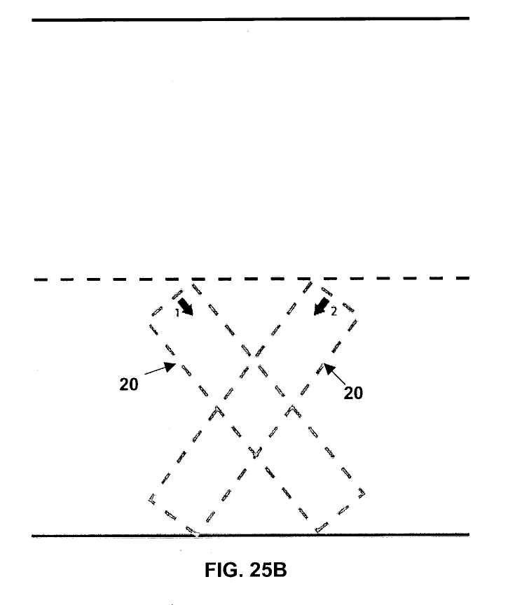

In FIG. 25A, the capital letter X is formed using two long straight line segments 15.

In FIG. 25B, a lower case letter x is formed using two medium straight line segments 20.

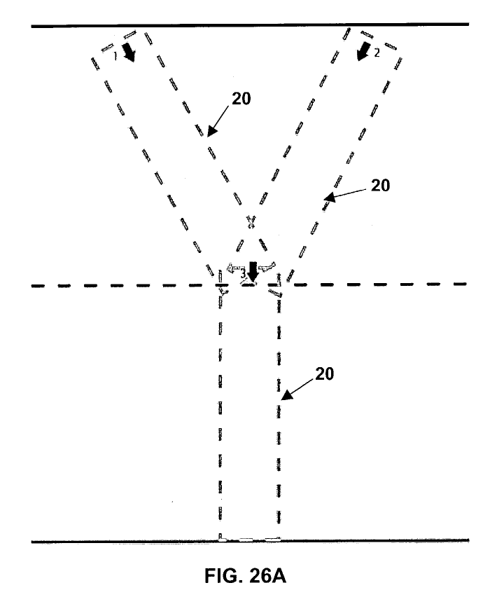

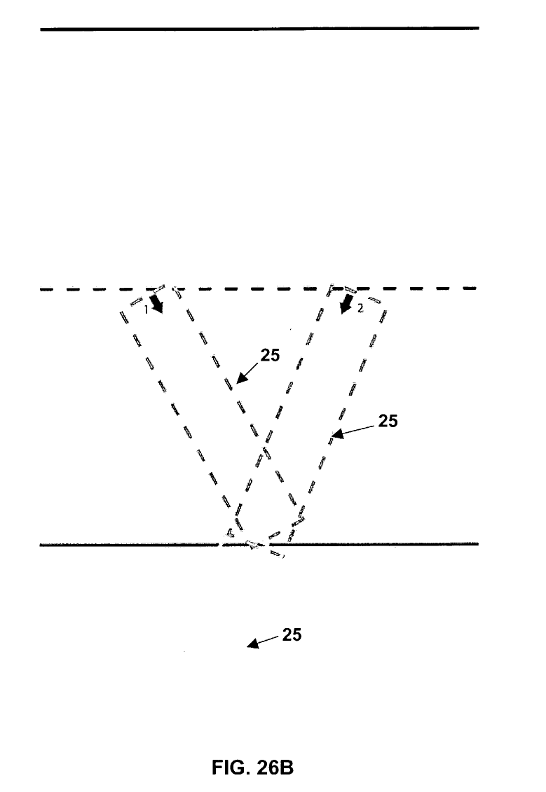

In FIG. 26A, a capital letter Y is formed using three medium straight line segments 20.

In FIG. 26B, a lower case letter y is formed using two medium straight line segments 20 and a short straight line segment 25.

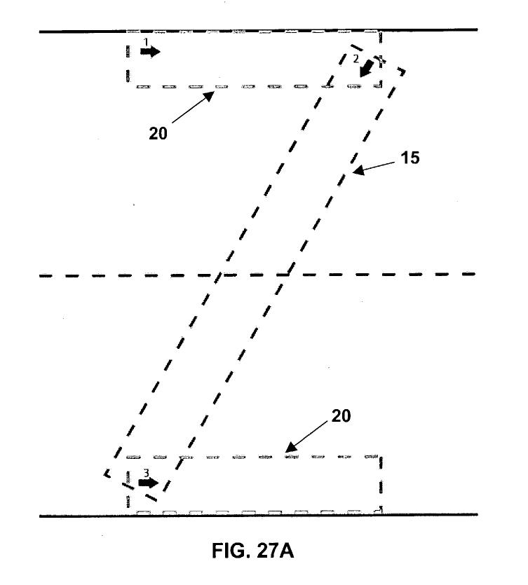

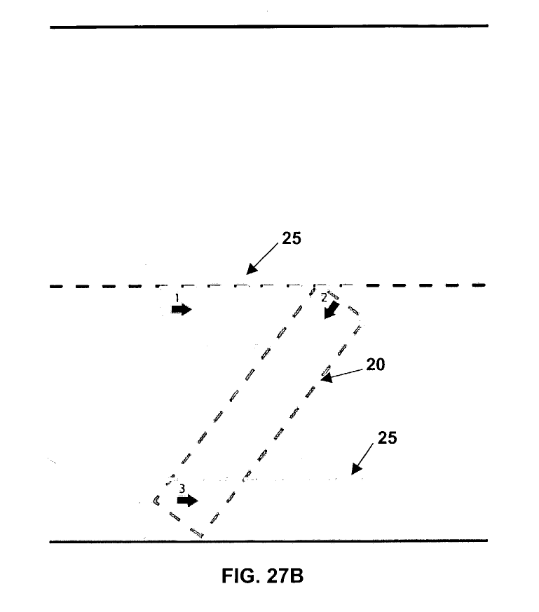

In FIG. 27A, a capital letter Z is formed using a long straight line segment and two medium straight line segments 20.

Finally, a lower case letter z is formed in FIG. 27B using one medium straight line segment 20 and two short straight line segments 25.

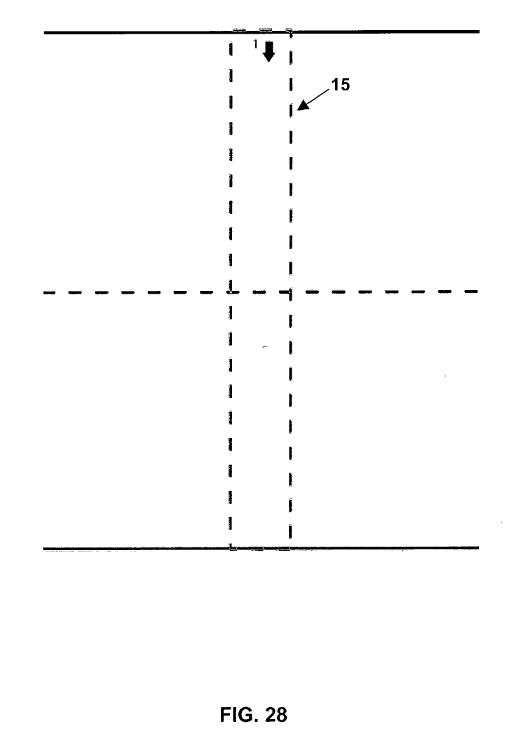

In FIG. 28, the numeral 1 is shown formed from a single long straight line piece 15.

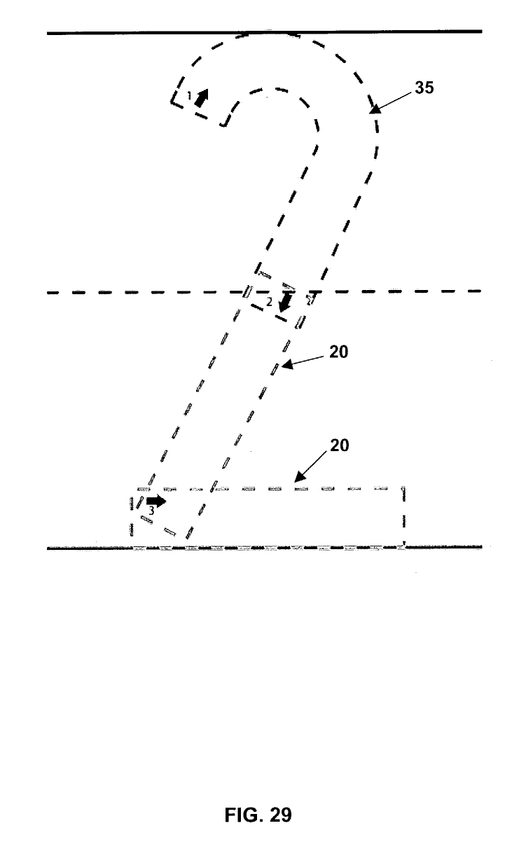

FIG. 29 shows the numeral 2 formed from a large hook piece 35 and two small straight line pieces 25.

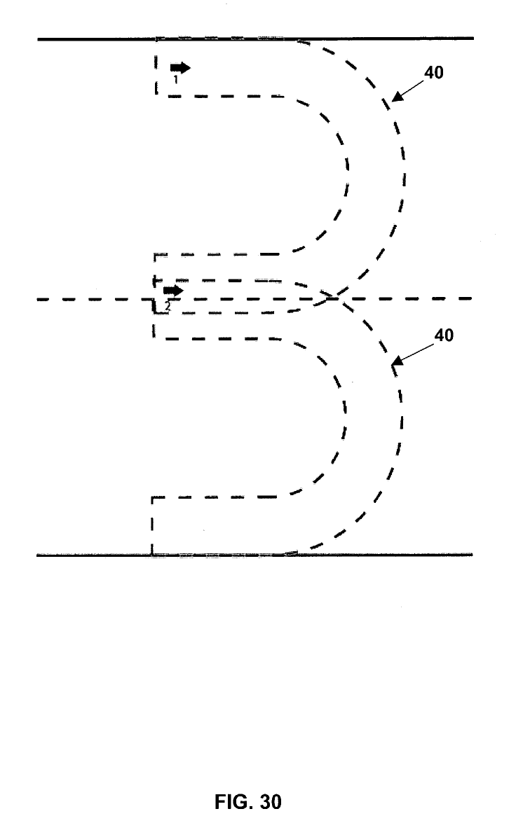

The numeral 3 is formed as shown in FIG. 30 using two u-shaped pieces 40.

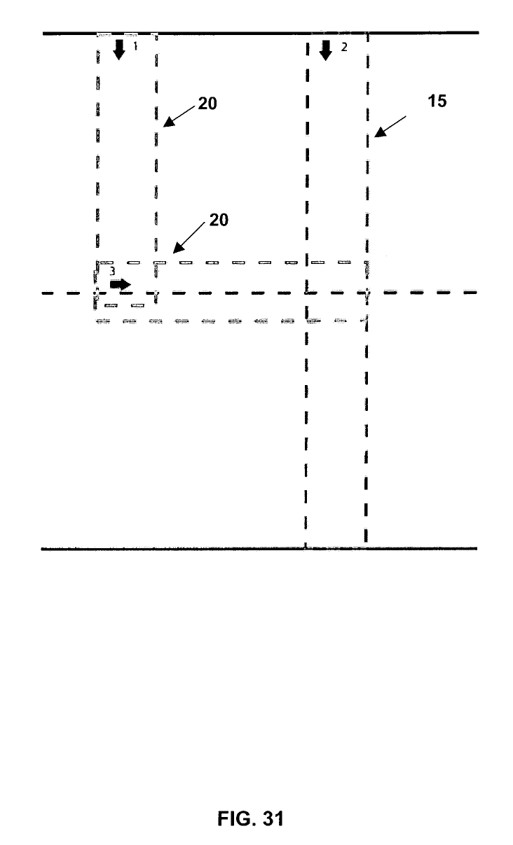

In FIG. 31, the numeral 4 is shown formed from a single long straight line piece 15 and two medium straight line pieces 20.

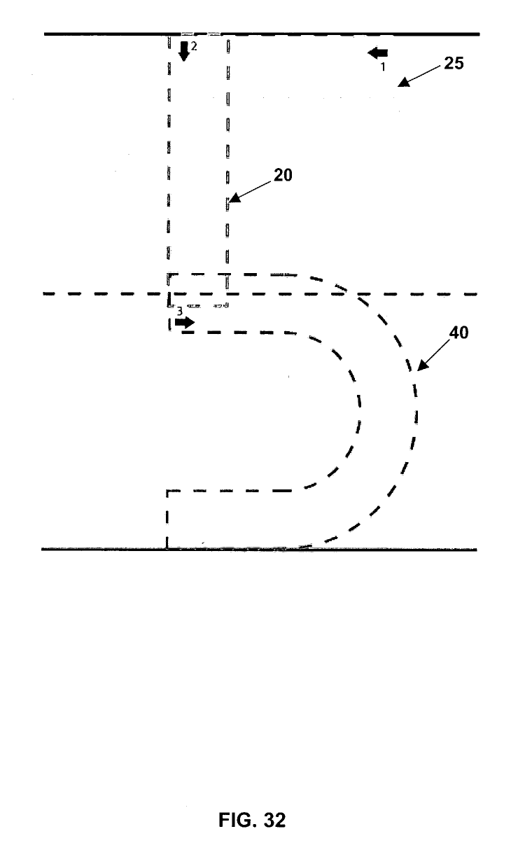

FIG. 32 shows the numeral 5 formed from a u-shaped piece 40, a short straight line piece 25, and a medium straight line piece 20.

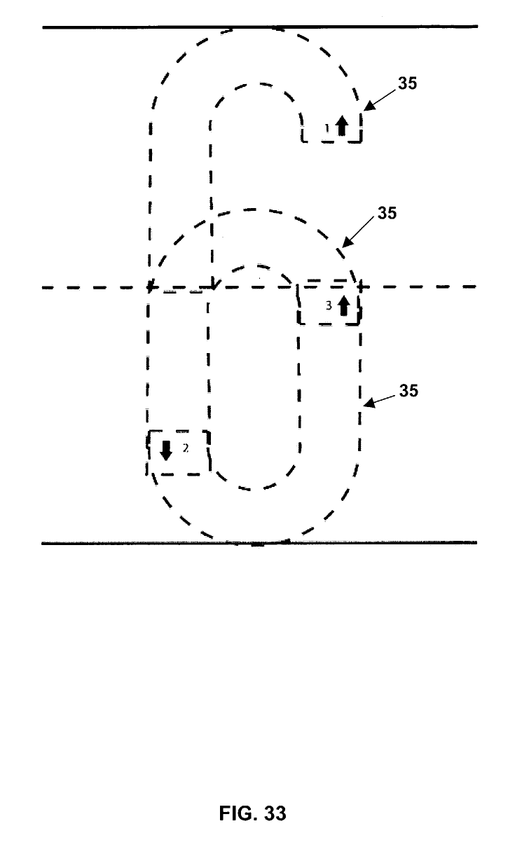

The numeral 6 is shown in FIG. 33 using three large hook-shaped pieces 35.

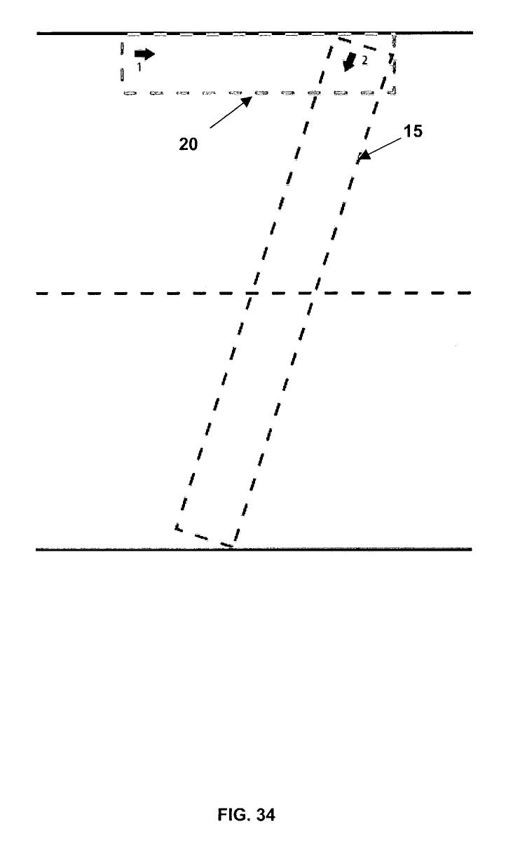

The numeral 7 is shown in FIG. 34 as a combination of a long straight line piece 15 and a medium straight line piece 20.

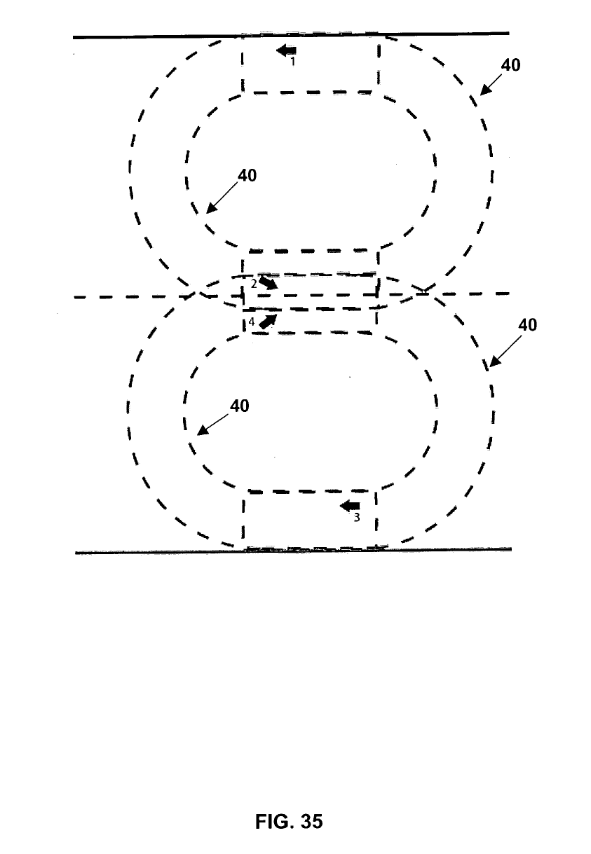

FIG. 35 shows the numeral 8 made from four u-shaped pieces 40.

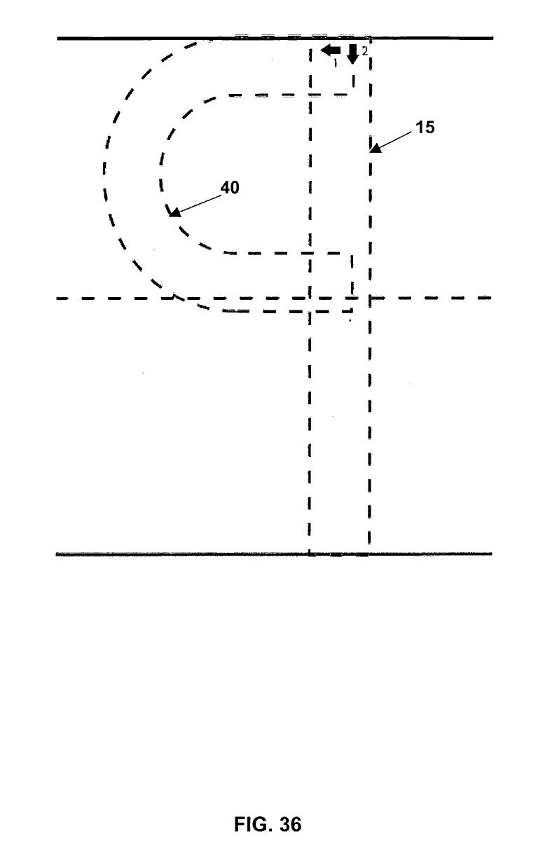

FIG. 36 shows the numeral 9 as consisting of a large straight line piece 15 and a u-shaped piece 40.

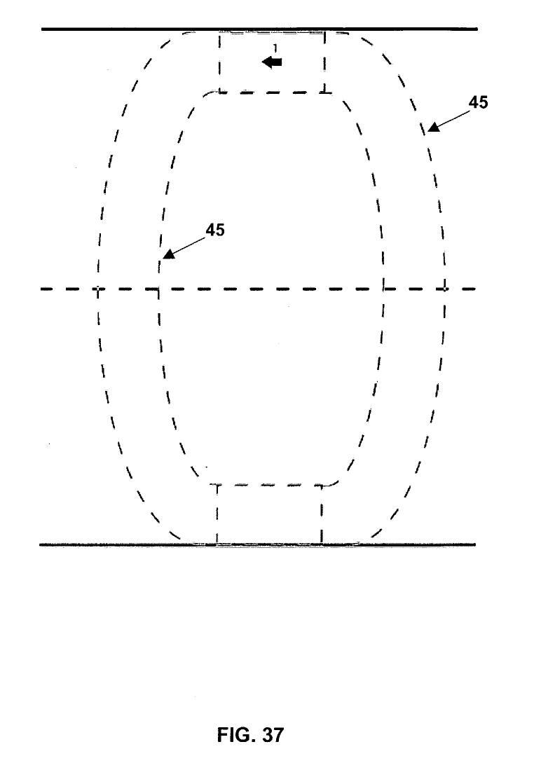

FIG. 37 depicts a zero as being formed from two C-shaped pieces 45.

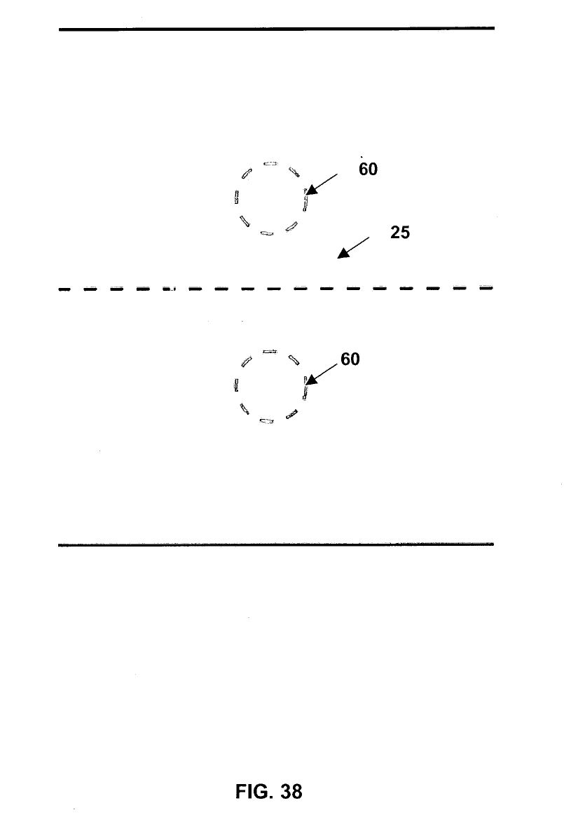

FIG. 38 is a division symbol formed from two dots 60 and a short straight line piece 25.

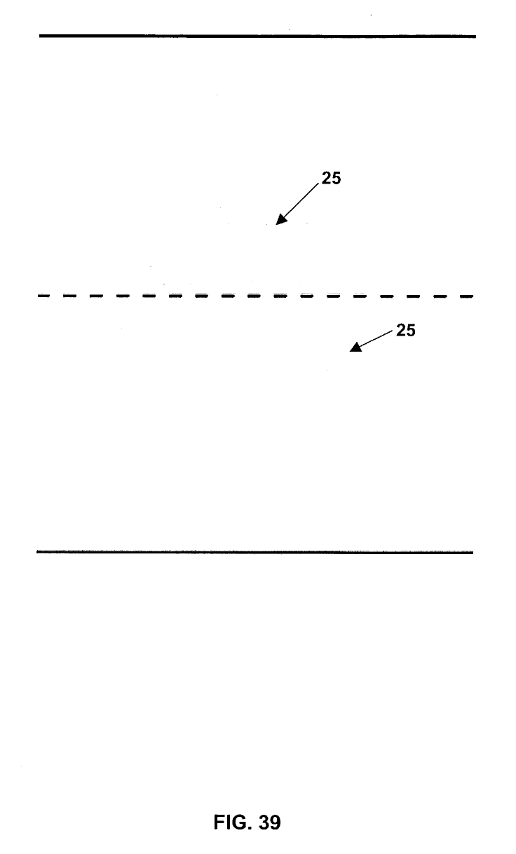

FIG. 39 is an equals symbol, including two short straight line pieces 25.

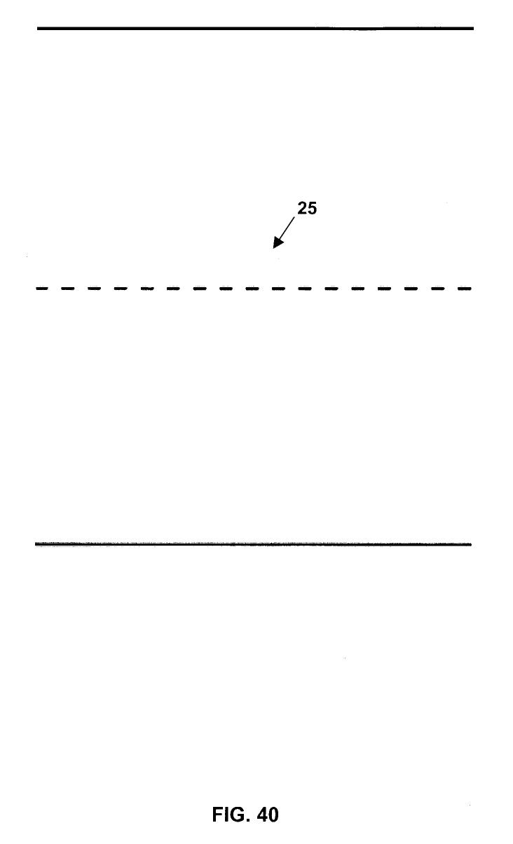

FIG. 40 is a minus symbol of just one short straight line piece 25.

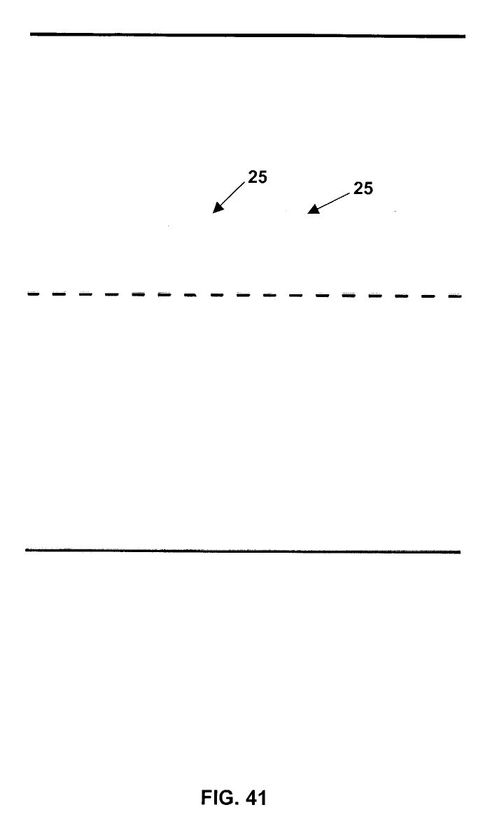

FIG. 41 is a multiplication symbol, including two short straight line pieces 25.

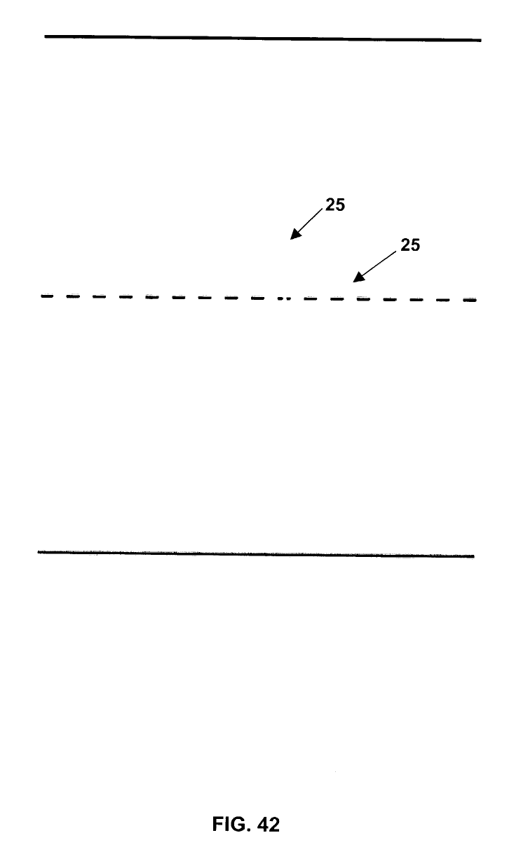

FIG. 42 is an addition symbol, also including two straight line pieces 25.

While the present invention is disclosed with respect to its utility for Latin-based languages, those of ordinary skill in the art will understand that the present invention may be used to teach the construction of letters, words, and numbers in a variety of different languages.

We claim:

1. An instructional aid for learning how to recognize and physically form letters of the alphabet, geometric shapes, and mathematical symbols typically used in writing, said instructional aid comprising:
a set of generic shapes representing the basic strokes found in portions of letters of the alphabet, numbers, words, geometric shapes, and mathematical symbols typically used in writing;
a set of cards preprinted with one of a selected letter of the alphabet, a number, a word, a geometric shape, or a mathematical symbol;
said pre-printed selected letter of the alphabet, number, word, geometric shape, or mathematical symbol being divided into segments corresponding to the individual shapes in said set of generic shapes;
whereby a learner will be able to form letters of the alphabet, numbers, words, geometric shapes, and mathematical symbols by matching said generic shapes with the shapes on said pre-printed cards.

2. The instructional aid as defined in claim 1 wherein said generic shapes are colored and wherein said colors match the shape of a colored generic shape on said pre-printed cards.

3. The instructional aid as defined in claim 1 wherein said pre-printed cards further include lines for guiding the position of the letter on the pre-printed card.

4. The instructional aid as defined in claim 1 wherein said generic shapes further include arrows depicting the direction of stroke for physically forming a letter of the alphabet.

5. A method for teaching how to recognize and physically form letters of the alphabet, geometric shapes, and mathematical symbols comprising the steps of:
creating a set of generic shapes found in portions of letters, words, geometric shapes, and mathematical symbols;
creating a set of cards depicting a selected letter, word, geometric shape, or mathematical symbol, as a set of generic shapes;
whereby a learner will be able to form letters, words, geometric shapes, and mathematical symbols by matching one or more of said generic shapes with a generic shape printed on a card.

6. The method as defined in claim 5 wherein said generic shapes are colored to match corresponding colored shapes on said cards.

7. The method as defined in claim 5 further including the step of forming lines on said cards to guide the position of the letters.

8. The method as defined in claim 5 wherein said generic shapes further include arrows depicting the direction of stroke for physically forming a letter of the alphabet.
